(19) United States
(12) Patent Application Publication
(10) Pub. No.: US 2005/0068317 A1
(43) Pub. Date: Mar. 31, 2005

(54) Program, method, and device for comparing three-dimensional images in voxel form

(75) Inventor: Makoto Amakai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/989,464

(22) Filed: Nov. 17, 2004

Related U.S. Application Data
(63) Continuation of application No. PCT/JP02/06621, filed on Jun. 28, 2002.

(51) Int. Cl. G06T 15/00

(52) U.S. Cl. 345/419

(57) ABSTRACT

Three-dimensional (3D) image comparison program, method, and device are provided to identify and display differences between given 3D images more quickly and accurately. A computer produces a 3D differential image by comparing given 3D images after converting them into voxel form. With respect to a surface voxel of the 3D differential image, the computer produces a 3D fine differential image containing fine-voxel images that provide details of the original first and second 3D images at a higher resolution than that of the 3D differential image. Subsequently, the computer determines a representation scheme from differences between the first and second 3D images by comparing their respective fine-voxel images. The computer outputs voxel comparison results on a display screen or the like by drawing the 3D differential image, including the surface voxel depicted in the determined representation scheme.

This application is a continuing application, filed under 35 U.S.C. §111(a), of International Application PCT/JP2002/006621, filed Jun. 28, 2002.

### BACKGROUND OF THE INVENTION

1. Field of the Invention

The present invention relates to a program, method, and device for comparing three-dimensional (3D) images and displaying differences therebetween. More particularly, the present invention relates to a 3D image comparison program, method, and device that use voxel-based techniques to compare given 3D images at a high accuracy.

2. Description of the Related Art

Three-dimensional imaging techniques are used in many fields today to represent an object on a computer screen. Such 3D images include, for example, design images created with 3D computer aided design (CAD) tools prevalent in various manufacturing industries. In the medical field, for example, solid images of affected part can be captured with a 3D ultrasonic diagnostic system.

One advantage of using 3D solid images in the engineering field is that they make it easy for designers to review their product design with a prototype, as well as for product inspectors to check manufactured products, with respect to the intended design image. In the medical field, solid images captured with a 3D ultrasonic diagnostic system will aid doctors to visually identify an illness or deformation at an affected part of the patient's body.

Such usage of 3D images dictates the development of an automated system that can compare images more efficiently and accurately. Particularly, the manufacturing industries need high-speed, high-accuracy measurement and comparison techniques in pursuit of better product quality and shorter development times. Images to be compared are: a CAD design model composed of 3D free-form surfaces and a set of point data of a product or component manufactured using that model, the latter being obtained by scanning an object with a 3D geometry measurement device. Also compared is a cross section or surface that is formed from such measured point data.

Conventional techniques for 3D image comparison evaluate differences between two surfaces in terms of the distance between a point on one surface and a corresponding point of the other surface. Such points are obtained through a measurement using a computed tomography (CT) scanner or a 3D digitizer, or alternatively, by subdividing a given surface into pieces with a certain algorithm. Surface-to-surface distance q at a particular point on one surface is the length of a perpendicular line drawn from that point to the other surface. Such distance data is plotted on a surface of interest, with color depths or intensities varied in proportion to the plotted values, or distances, for visualization of the data. A more specific explanation will be given below, with reference to FIG. 26.

FIG. 26 shows an example of a 3D image of an object (CAD data of 3D curved surface) and one element of a 3D point data set (measurement data). The 3D surface image shown in FIG. 26 is given by the following equation:
z=y³+3x²y (1)
For a given point (x₀, y₀, z₀), its distance to the surface is defined to be the minimum value of {(x−x₀) ²+(y−y₀) ²+(z−z₀)²}^{1/2}. This calculation is repeated extensively for all pieces of surface in the neighborhood of point (x₀, y₀, z₀), and the smallest among the resulting values is extracted as the point-to-image distance.

The above conventional comparison method will be discussed with reference to a conceptual view of FIG. 27. Illustrated in FIG. 27 are first and second surface data Im101 and Im102, the former being a design model and the other being a model built from photographs or the like. The conventional method is unable to compare those two sets of surface data directly. Therefore, according to the conventional method, the surface given by the second surface data Im102 is first converted into a set of discrete points, and this point data set PIm102 is then compared with the first surface data Im101.

Such a conventional method, however, needs to process a countless number of points if a high-accuracy is required. Besides, CAD models in real world product design are often made up of many small surfaces, meaning that the comparison process has to deal with a lot of point-to-surface combinations. Those facts lead to the problems of enormous amounts of computation time, and a possibility of obtaining incorrect results due to the difficulty in selecting a surface that is nearest to a given point.

The following table 1 gives some typical numbers of measurement points required in the manufacturing industries, where plastics products are supposed to need five times as many measurement points as estimated from their surface area (400 mm×400 mm). As can be seen, none of the existing methods are realistic because of too many measurement points.

TABLE 1

| | Required | Component | |
|---|---|---|---|
| Type | Resolution | Size | Measurement points |
| Plastics | 0.01 | 400 × 400 × 20 | 10 billion points |
| Products | (mm) | (mm) | (component surfaces only) |
| Casting | 0.1 | 400 × 400 × 350 | 50 billion points |
| Products | (mm) | (mm) | (including those inside |
| | | | the component) |

### SUMMARY OF THE INVENTION

In view of the foregoing, it is an object of the present invention to provide a 3D image comparison program, method, and device for comparing 3D images more quickly and accurately.

According to a first aspect of the present invention, there is provided a 3D image comparison program in order to solve the foregoing problems. When executed by a computer, this 3D image comparison program compares first and second 3D images and displays their differences as follows. The computer first produces a 3D differential image by converting given first and second 3D images into voxel form and making a comparison between the two voxel-converted images. Then with respect to a surface voxel of this 3D differential image, the computer produces a 3D fine differential image that provides fine-voxel images that provide details of the first and second 3D images at a higher resolution than that of the 3D differential image. The computer determines a representation scheme from differences between the first and second 3D images in their respective fine-voxel images. The computer then displays the 3D differential image including the surface voxel drawn in the determined representation scheme.

According to a second aspect of the present invention, there is provided another 3D image comparison program designed to solve the foregoing problems. When executed by a computer, this comparison program compares first and second 3D images and displays their differences as follows. The computer produces a 3D differential image by converting given first and second 3D images into voxel form and making a comparison between the two voxel-converted images. Out of this 3D differential image, the computer extracts a dissimilar part and counts voxel mismatches perpendicularly to each surface of a reference voxel selected from an outermost layer of matched voxels that is revealed. Based on that count, the computer determines a representation scheme for each surface of the reference voxel, and displays each surface of the reference voxel in the corresponding representation scheme.

According to a third aspect of the present invention, there is provided another 3D image comparison program designed to solve the foregoing problems. When executed by a computer, this 3D image comparison program compares first and second 3D images and displays their differences as follows. The computer first produces a 3D differential image by converting given first and second 3D images into voxel form and making a comparison between the two voxel-converted images. The computer then calculates a ratio of the number of surface voxels of a dissimilar part of the 3D differential image to the total number of voxels constituting the dissimilar part, and based on that ratio, it determines a representation scheme for visualizing voxel mismatches on the 3D differential image. The computer displays the dissimilar part of the 3D differential image in the representation scheme determined from the ratio.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a first embodiment of the invention.

FIG. 2 is a conceptual view of a voxel-based 3D image comparison method according to the first embodiment.

FIG. 3 shows an example of a computer hardware structure that is suitable for execution of a 3D image comparison program.

FIG. 4 is a block diagram showing a functional structure of a 3D image comparison device.

FIG. 5 gives an overview of a comparison process of the 3D image comparison program.

FIG. 6 shows fine-voxel comparison of two 3D images, which is made after the initial comparison is completed.

FIG. 7 shows a color for common voxels, which is selected in a process of setting colors according to voxel mismatch count.

FIG. 8 shows a color for a voxel mismatch belonging to the reference image, which is selected in the process of setting colors according to voxel mismatch count.

FIG. 9 shows a color for a voxel mismatch belonging to the subject image, which is selected in the process of setting colors according to voxel mismatch count.

FIG. 10 shows the relationship between voxel element numbers and articulation point numbers.

FIG. 11 shows a typical data structure representing articulation points of a 3D image.

FIG. 12 shows a data structure of voxel representation using articulation points.

FIG. 13 is a flowchart showing the entire process flow of 3D image comparison.

FIG. 14 is a flowchart of a comparison data entry process as part of the 3D image comparison process of FIG. 13.

FIG. 15 is a flowchart of voxel processing as part of the 3D image comparison process of FIG. 13.

FIG. 16 is a flowchart of an image positioning process as part of the 3D image comparison process of FIG. 13.

FIG. 17 is a flowchart of a first image comparison process as part of the 3D image comparison process of FIG. 13.

FIG. 18 gives an overview of a comparison process performed with a 3D image comparison program according to a second embodiment.

FIG. 19 is a flowchart of a second image comparison process as part of the 3D image comparison process of FIG. 13.

FIG. 20 shows a first example of a difference that is evaluated by a 3D image comparison program according to a third embodiment of the invention.

FIG. 21 shows a light color determined by the 3D image comparison program of the third embodiment.

FIG. 22 shows a second example of a difference that is evaluated by the 3D image comparison program of the third embodiment.

FIG. 23 shows a deep color determined by the 3D image comparison program of the third embodiment.

FIG. 24 shows a third example of a difference that is evaluated by the 3D image comparison program of the third embodiment.

FIG. 25 is a flowchart of a third image comparison process as part of the 3D image comparison process of FIG. 13.

FIG. 26 shows a 3D image of an object (CAD data of 3D curved surface) and one element of a 3D point data set (measurement data).

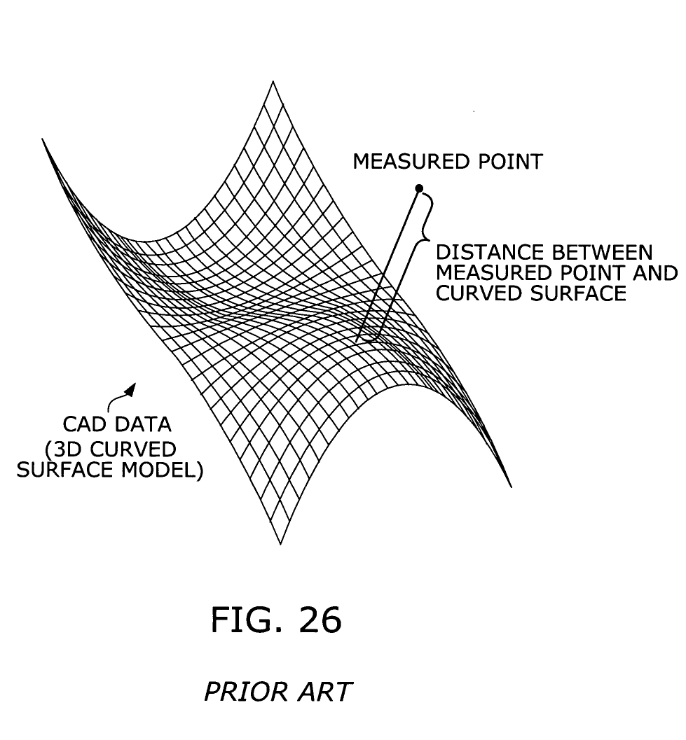

FIG. 27 is a conceptual view of a conventional 3D image comparison method.

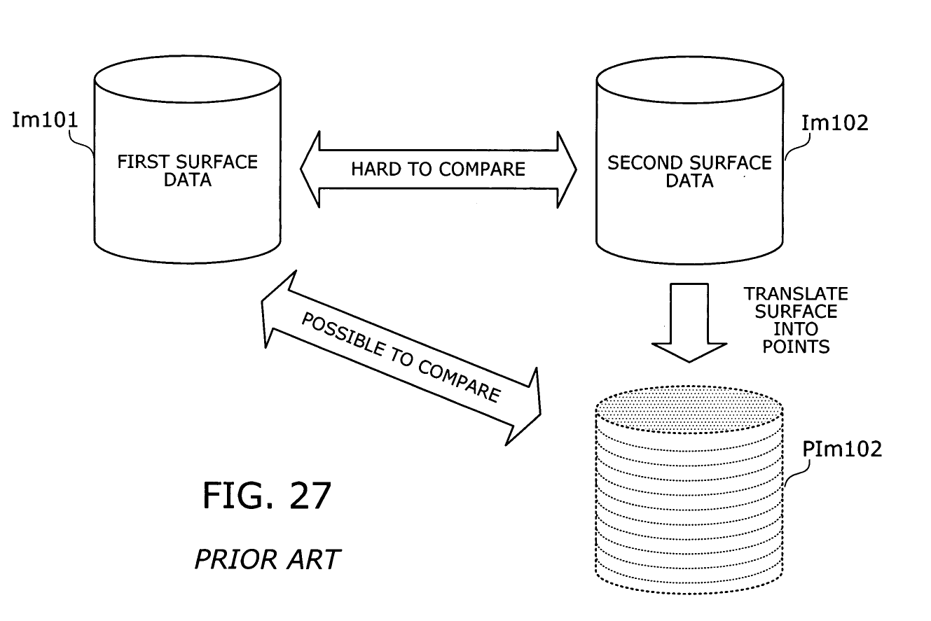

### DESCRIPTION OF THE PREFERRED EMBODIMENTS

The present invention is directed to geometrical comparison of 3D images such as:
CAD design data for producing a physical object
computer graphics (CG) images, such as those seen in computer games
scanned data of a physical object (e.g., industrial products, natural products, organisms and their organs)
   According to the present invention, two such 3D images are translated into uniform cubes, or rectangular solids called “voxels,” before they are actually compared with each other. Comparison of given 3D images is implemented as voxel-by-voxel Boolean operations, where the images have to be positioned properly with respect to their fiducial points, or particular geometrical features that they both have. After a voxel-based comparison, the two images' geometrical dissimilarity is evaluated in terms of the number of voxel mismatches. In the case a CAD-generated 3D surface model is given as a reference image for comparison, the results are visualized such that the information about voxel mismatches will be seen in some way on that 3D surface.

The comparison process outlined above can be realized in several different ways in terms of how to visualize mismatched part of 3D images. The present invention offers the following implementations for this:

(1) After 3D images are compared in the voxel domain, their differences are visualized in a particular representation scheme (e.g., by different voxel colors) determined on an individual voxels basis.

(2) With each dissimilar part discovered, voxel mismatches are counted in the perpendicular direction (x, y, or z direction) from each surface of a voxel that is selected from among those on the outermost layer of matched voxels. The resulting count values are used to determine representation schemes for the corresponding surfaces of that voxel (called a reference voxel). Comparison results are thus visualized as different surface colors of a reference voxel by color-coding the thickness of the corresponding dissimilar part.

(3) The difference between 3D images is visualized in a predetermined representation scheme based on the ratio of volume versus surface area of each dissimilar part. That is, differences of 3D images are visualized on the basis of a factor that characterizes each dissimilar part in its entirety (i.e., by color-coding surface-to-volume ratios)

This description covers those three visualization methods (1)-(3) in separate embodiments. Specifically, a first embodiment of the invention provides a 3D image comparison program, method, and device that visualize differences between 3D images in the first way (1) mentioned above. A second embodiment of the invention provides a 3D image comparison program, method, and device that visualize differences between 3D images in the second way (2). A third embodiment of the invention provides a 3D image comparison program, method, and device that visualize differences between 3D images in the third way (3). Those preferred embodiments of the present invention will now be described in detail below with reference to the accompanying drawings, wherein like reference numerals refer to like elements throughout.

### First Embodiment

This section explains a first embodiment of the invention, in which 3D images are compared on an individual voxel basis and their differences are visualized in a particular representation scheme.

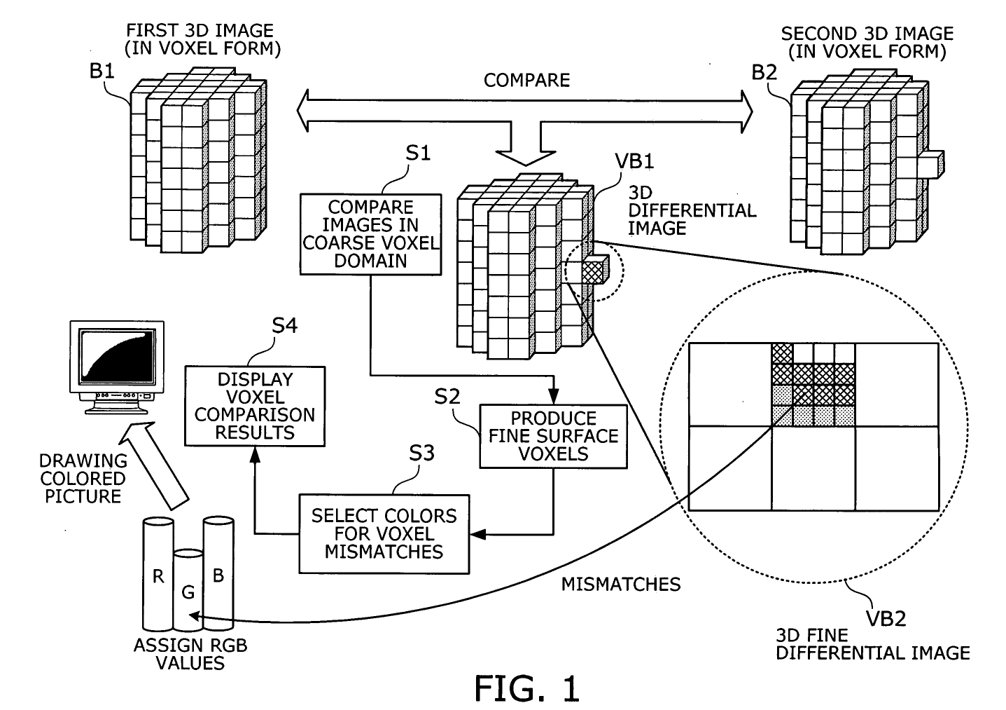

FIG. 1 is a conceptual view of the first embodiment. Provided here is a 3D image comparison program according to the first embodiment which causes a computer to compare 3D images and visualize their differences according to the steps described below. Briefly, the computer compares a first 3D image B1 representing a design model in voxel form with a second 3D image B2 representing measurement results in voxel form and displays their differences in a particular representation scheme.

At step 1, the computer converts given first and second 3D images B1 and B2 into voxel form. The computer then compares the two 3D images B1 and B2 in the voxel domain, thereby producing a 3D differential image VB1 that represents their differences and similarities distinguishably. At step S2, with respect to a surface voxel of this 3D differential image VB1, the computer produces a 3D fine differential image VB2 of the 3D images B1 and B2. This 3D fine differential image VB2 contains fine-voxel images that provides local details of the original 3D images B1 and B2 in that surface voxel, at a higher resolution than that of the 3D differential image. Subsequently, at step S3, the computer determines a representation scheme from differences between the first and second 3D images in their respective fine-voxel images. Lastly, at step S4, the computer outputs voxel comparison results on a display screen or the like by drawing the 3D differential image VB1, where the surface voxel is depicted in the determined representation scheme. The voxel comparison results may be output, not only on a display screen, but to a printer, plotter, or other devices. In this way, the given 3D images can be compared quickly and accurately.

The term “representation scheme” is used to actually refer to an additive mixture of red, green, and blue (RGB), or the three primary colors of light. As an alternative scheme, it may be a subtractive mixture of cyan, magenta, and yellow (CMY), which are known as complementary primary colors. This subtractive color mixture may include black as an additional element.

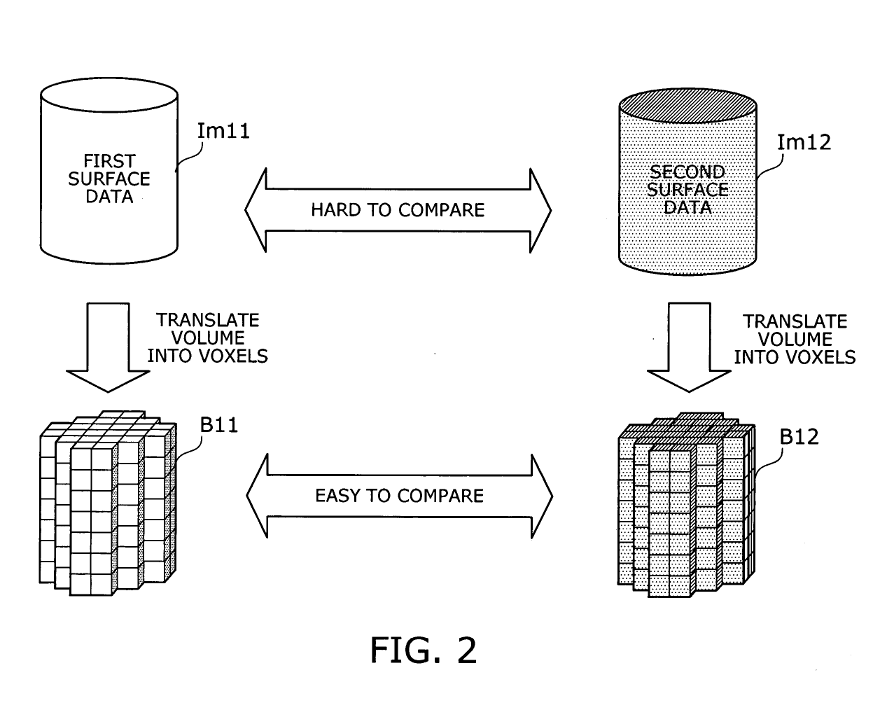

Referring next to FIG. 2, the concept of a voxel-based 3d image comparison method according to the first embodiment will be described below. Shown in FIG. 2 are first surface data Im11 representing a design model and second surface data Im12 obtained through measurement (e.g., by scanning an object). Since those two sets of surface data cannot be compared directly, the 3D image comparison method of the first embodiment begins processing with converting a volume defined by the first surface data Im11 into a chunk of voxels B11, as well as that of the second surface data Im12 into another chunk of voxels B12. The method then compares those two chunks of voxels B11 and B12, thereby overcoming the difficulty of comparing two 3D images.

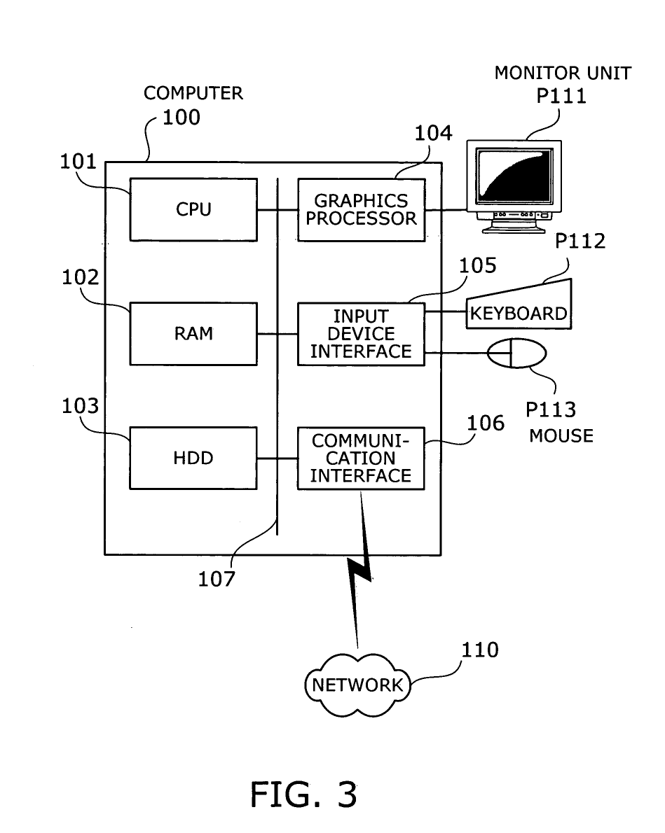

Referring now to FIG. 3 and subsequent drawings, the following will give more specifics about the first embodiment of the present invention.

FIG. 3 shows an example of a computer hardware structure that is suitable for execution of a 3D image comparison program. The illustrated computer 100 has a central processing unit (CPU) 101 to control the entire system, interacting with the following components via a bus 107: a random access memory (RAM) 102, a hard disk drive (HDD) 103, a graphics processor 104, an input device interface 105, and a communication interface 106.

The RAM 102 temporarily stores the whole or part of operating system (OS) programs and application programs that the CPU 101 executes, as well as other various data objects manipulated by the CPU 101 at runtime. The HDD 103 stores program and data files of the operating system and various applications including a 3D image comparison program. The graphics processor 104 is coupled to an external monitor unit P111. The graphics processor 104 produces video images in accordance with drawing commands from the CPU 101 and displays them on the screen of the monitor unit P111. The input device interface 105 is coupled to a keyboard P112 and a mouse P113, so that input signals from the keyboard P112 and mouse P113 will be supplied to the CPU 101 via the bus 107. The communication interface 106 is linked to a network 110, permitting the CPU 101 to exchange data with other computers.

The computer 100 with the above-described hardware configuration will function as a 3D image comparison device when a 3D image comparison program is running thereon. The following will now explain what processing functions the computer, as a 3D image comparison device, is supposed to provide.

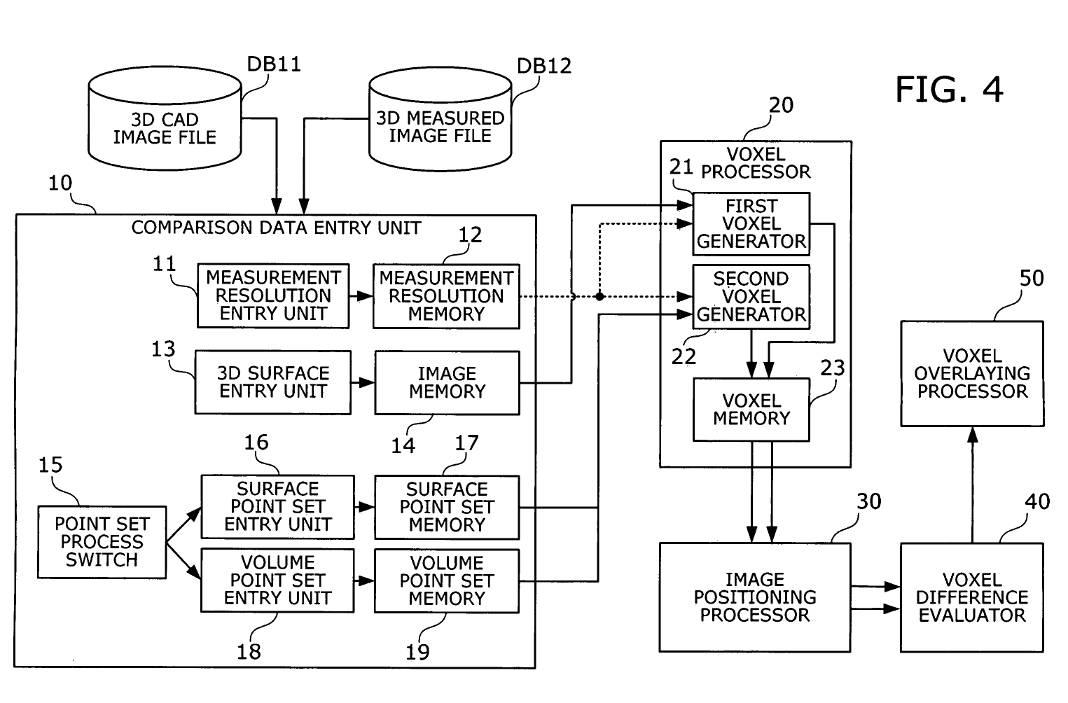

FIG. 4 is a block diagram showing a functional structure of a 3D image comparison device according to the invention. This structure applies all the first to third embodiments. The illustrated 3D image comparison device has the following elements: a comparison data entry unit 10 for entering comparison data; a voxel processor 20 for producing voxels from given 3d images; an image positioning processor 30 for positioning voxel-converted 3D images; a voxel difference evaluator 40 for evaluating and displaying voxel mismatches; and a voxel overlaying processor 50 for overlaying those voxels for display.

The comparison data entry unit 10 has, among others, the following functional elements: a measurement resolution entry unit 11, a measurement resolution memory 12, a 3D surface entry unit 13, an image memory 14, a point set process switch 15, a surface point set entry unit 16, a surface point set memory 17, a volume point set entry unit 18, and a volume point set memory 19. The voxel processor 20 has, among others, a first voxel generator 21, a second voxel generator 22, and a voxel memory 23. Those functional elements will now be described below in detail, in the order that they have been mentioned above.

The comparison data entry unit 10 manages a process of accepting entry of source image data, such as CAD data and measurement data, for 3D image comparison. When a command for 3D image data entry is received from a user, the comparison data entry unit 10 identifies the image type of each specified 3D image. The comparison data entry unit 10 also checks whether 3D images have been entered to relevant storage spaces, i.e., the image memory 14, surface point set memory 17, or volume point set memory 19, as specified by the user.

Source image data for comparison are supplied from a 3D CAD image file DB11 and a 3D measured image file DB12. The 3D CAD image file DB11 stores CAD data of a 3D surface model. The 3D measured image file DB12 stores measurement results including surface measurement data and section measurement data.

The measurement resolution entry unit 11 receives a measurement resolution parameter from the user. This measurement resolution parameter gives a minimum size of voxels into which 3D images are to be divided. The user can specify a desired size for this purpose, and preferably, the resolution is as fine as the precision required in manufacturing a product of interest, which is, for example, 0.01 mm. The measurement resolution memory 12, coupled to the measurement resolution entry unit 11, stores the measurement resolution parameter that is received.

The 3D surface entry unit 13 is activated when the image type of a user-specified 3D image turns out to be “3D surface model.” The 3D surface entry unit 13 receives 3D surface data from the 3D CAD image file DB11. The image memory 14, coupled to the 3D surface entry unit 13, stores this received 3D surface data in an internal storage space.

The point set process switch 15 is coupled to a surface point set entry unit 16 and a volume point set entry unit 18 to select either of them to handle a given point set data. Depending on the image type of a user-specified 3D image, which may be “surface measurement data” or “section measurement data” in this case, the point set process switch 15 activates either the surface point set entry unit 16 or volume point set entry unit 18.

The surface point set entry unit 16 handles entry of surface measurement data. When the image type of a user-specified 3D image turns out to be “surface measurement data,” the surface point set entry unit 16 is activated to receive surface measurement data from the 3D measured image file DB12. The surface point set memory 17 stores the received surface measurement data in its internal storage space. The volume point set entry unit 18, on the other hand, handles entry of section measurement data. When the image type of a user-specified 3D image turns out to be “section measurement data,” the volume point set entry unit 18 is activated to receive section measurement data from a 3D measured image file DB12. The volume point set memory 19 stores the received section measurement data in its internal storage space.

The voxel processor 20 is placed between the comparison data entry unit 10 and image positioning processor 30. The voxel processor 20 produces an image in voxel form from a 3D image supplied from the comparison data entry unit 10. Specifically, the voxel processor 20 selects comparison data recorded in the comparison data entry unit 10. Also, the voxel processor 20 determines the voxel size from the measurement resolution parameter recorded in the comparison data entry unit 10. Then, with reference to the image type of each 3D image stored in the comparison data entry unit 10, the voxel processor 20 determines what to do at the next step.

More specifically, in the case the image type indicates that the image in question is a 3D surface, the voxel processor 20 retrieves relevant 3D surface data out of the image memory 14 and supplies it to a first voxel generator 21. The first voxel generator 21 creates a voxel-converted image from given 3D surface data.

In the case the image type indicates that the image in question is surface measurement data, the voxel processor 20 retrieves relevant surface measurement data out of the surface point set memory 17 and supplies it to a second voxel generator 22. Further, in the case the image type indicates that the image in question is section measurement data, the voxel processor 20 retrieves relevant section measurement data out of the volume point set memory 19 and supplies it to the second voxel generator 22. The second voxel generator 22 creates a voxel-converted image from given surface measurement data or given section measurement data. The voxel processor 20 checks whether the two voxel generators 21 and 22 have successfully produced voxel-converted images.

The image positioning processor 30 is placed between the voxel processor 20 and voxel difference evaluator 40 to align the two voxel-converted images supplied from the voxel processor 20. More specifically, two 3D images (i.e., one is CAD data representing a 3D surface, and the other is surface measurement data or section measurement data obtained through measurement) have a set of fiducial points that are previously specified in each of them. The image positioning processor 30 selects those fiducial points and calculates the offset of each images from the selected fiducial points. The image positioning processor 30 moves the voxel-converted 3D images, based on the calculated offsets, and then it stores the moved images in its internal storage space.

The voxel difference evaluator 40 is placed between the image positioning processor 30 and voxel overlaying processor 50. The voxel difference evaluator 40 compares and evaluates two images properly positioned by the image positioning processor 30 and displays the results by visualizing differences between the two images in a particular representation scheme, e.g., by using RGB colors with particular depths.

More specifically, the voxel difference evaluator 40 selects a surface voxel of a 3D differential image and applies an additional voxel conversion to that part at a specified test resolution. That is, the selected surface voxel is subdivided into smaller voxels. The size of those “fine voxels” is determined according to a test resolution, which may be specified previously by the user. This test resolution may initially be set to several times as coarse as the measurement resolution, and later be varied stepwise to evaluate images at a finer resolution. The voxel difference evaluator 40 makes a comparison between the reconverted 3D surface and surface/section measurement data in the fine voxel domain and counts their voxel mismatches. The details of this comparison process will be discussed later.

Based on the number of voxel mismatches, the voxel difference evaluator 40 then determines a color depth as a representation scheme to be used, so that the voxel of interest will be colored. The voxel difference evaluator 40 determines whether all surface voxels are colored in this way, meaning that it checks whether the comparison of voxel-converted 3D images is completed.

The voxel overlaying processor 50, coupled to the voxel difference evaluator 40, aligns and combines a plurality of resulting voxel images processed by the voxel difference evaluator 40.

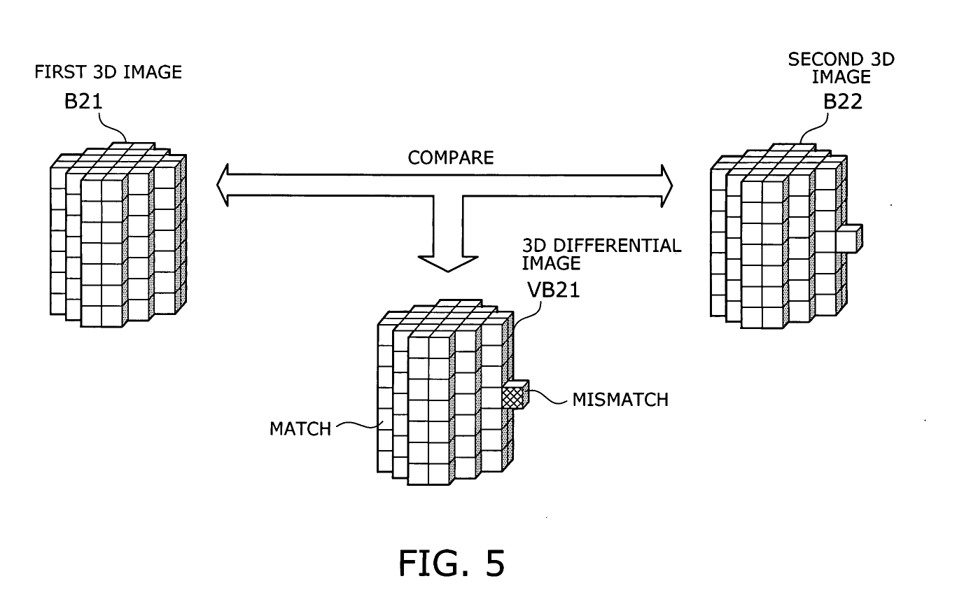

Referring next to FIGS. 5 to 9, the following will provide more specifics about the comparison process implemented in a 3D image comparison program according to the first embodiment of the invention.

The first embodiment reduces computation time by comparing 3D shapes in the voxel domain. Think of, for example, a CAD-generated image of an object having 3D curved surfaces. The image space is divided into uniform, minute cubes, or voxels, and a 3D image of that object is created by setting every voxel belonging to the object to ON state and every other outer voxel to OFF state. In the case the source image data is given as an output of an X-ray CT scanner, voxels are set to ON state if they have high x-ray densities, while the others are set to OFF state.

Referring to FIG. 5, the following will provide a brief explanation of how voxels are compared by a 3D image comparison program. The comparison process converts two given images into voxel form, like 3D images B21 and B22 shown in FIG. 5, and applies Boolean operations to their corresponding portions to discover their differences (voxel mismatches) and similarities (voxel matches) in the form of a 3D differential image VB21. This method reduces computational load by a factor of several tens, compared to conventional methods discussed earlier in this description. Boolean operations include an exclusive-OR (XOR) operation between voxels of 3D images B21 and B22, which extracts voxel mismatches.

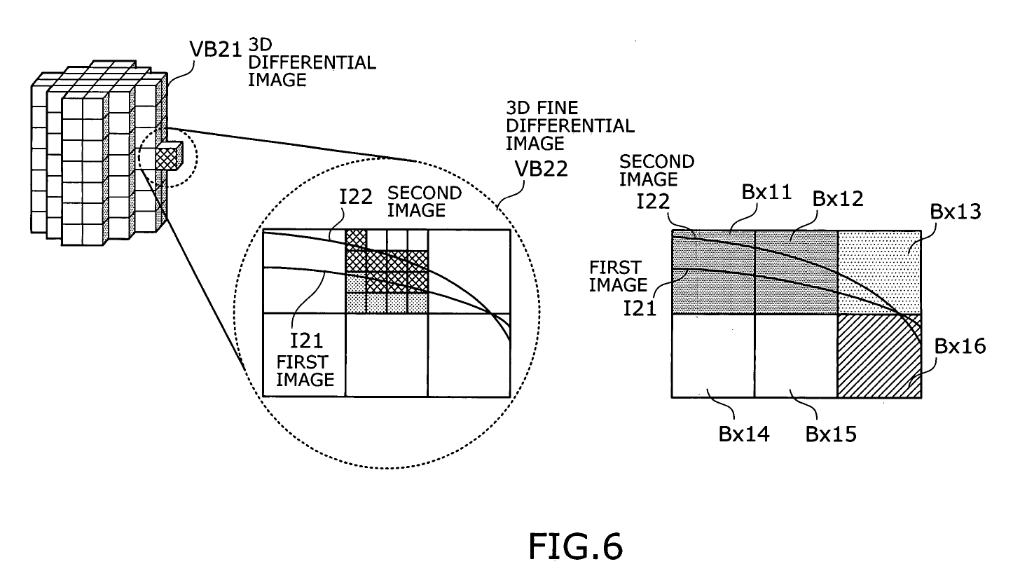

The initial voxel resolution of 3D images is relatively coarse compared to test resolution. The comparison process then produces fine voxels for each coarse voxel in order to find and evaluate differences between the images in terms of the number of voxel mismatches. This difference information in numerical form is then put on one of the two images in visual form, so that the user can recognize it visually. The following will describe the mechanism for this feature, with reference to FIG. 6.

FIG. 6 shows a fine-voxel comparison of two 3D images, which is made after an initial coarse-voxel comparison is finished. The process assumes that a 3D differential image VB21 has been produced in coarse voxel form as shown in FIG. 6. Voxels on the surface of this 3D differential image VB21 are subdivided into fine voxels (3D fine differential image VB22), so that the difference between two images can be evaluated in terms of the number of mismatches in fine voxels observed therein. Specifically, in FIG. 6, the 3D fine differential image VB22 of one coarse voxel contains eight fine voxels that are different between two source images 121 and 122.

The process now proceeds to the step of determining voxel color depths based on the number of mismatches in each surface voxel, so that the entire difference can be identified visually. As shown in the example of FIG. 6, voxels Bx11, Bx12, and Bx13 are given particular colors (e.g., several blues with different depths), indicating that the voxel mismatches belong to the second image 122, but not to the first image 121. Another voxel Bx16 is given another particular color (e.g., red with a certain depth), indicating that this mismatch belongs to the first image 121, but not to the second image 122. The remaining voxels Bx14 and Bx15 have no colors assigned, meaning that no mismatches are found at that portion.

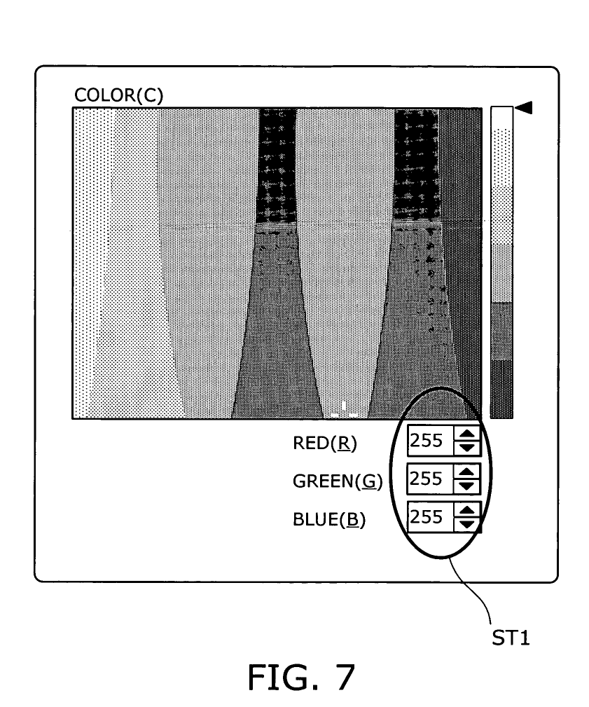

Voxels are subdivided in the proportion of one coarse voxel to four fine voxels in the example of FIG. 6. This means that the magnitude of three-dimensional mismatch in a coarse voxel can take a value of 64 (4×4×4) at maximum. Referring next to FIGS. 7 to 9, the following will describe how a color is determined when a mismatch count is given.

FIG. 7 shows a color for common voxels, which is selected in a process of setting colors according to voxel mismatch count. The control boxes in area ST1 indicates that maximum intensities (e.g., 255, 255, 255) are given to three colors RGB to represent common voxels (i.e., voxels with no mismatch).

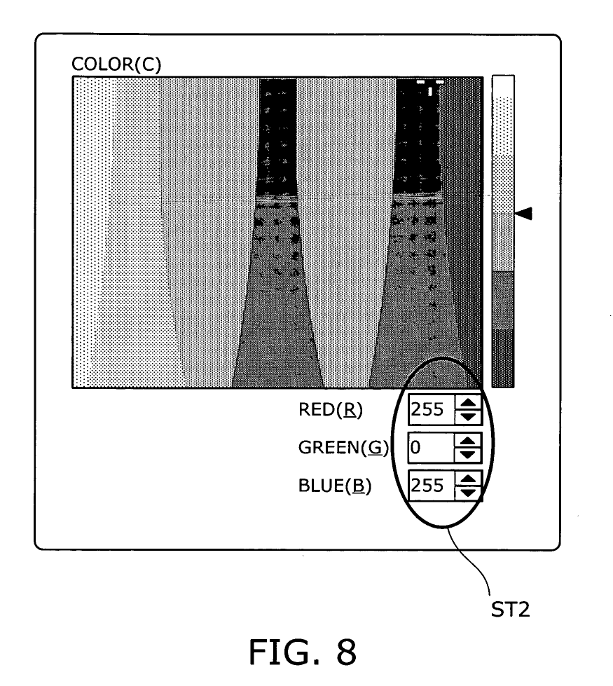

FIG. 8 shows a color for a voxel mismatch belonging to the reference image, which is selected in the process of setting colors according to voxel mismatch count. In the example of FIG. 8, the central control box in area ST2 indicates that the intensity of green (G) is decreased in accordance with the number of voxel mismatches. The colors determined in this way are used to color-coding voxels at which the reference image lies inside the subject image.

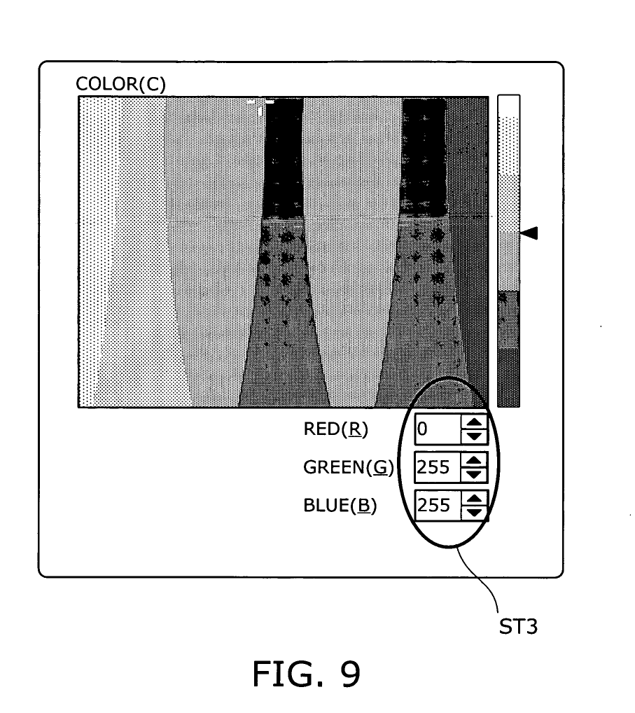

FIG. 9 shows a color for a voxel mismatch belonging to the subject image, which is selected in the process of setting colors according to voxel mismatch count. In the example of FIG. 9, the topmost control box in area ST3 indicates that the intensity of red (R) is decreased in accordance with the number of voxel mismatches, as shown in FIG. 9. The colors determined in this way are used to color-coding voxels at which the subject image lies inside the reference image.

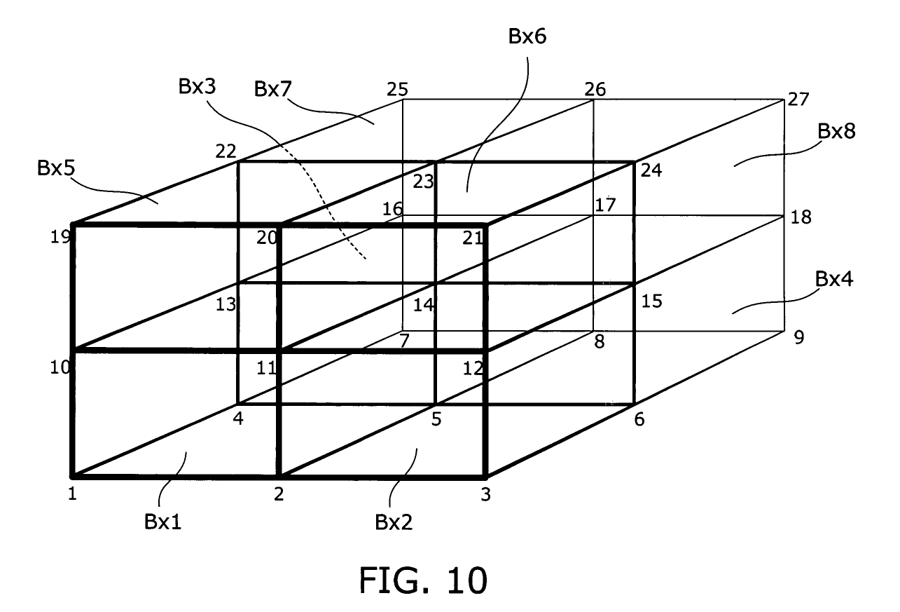

As has been described in FIGS. 7 to 9, the color values are determined in proportion to the number of mismatched fine voxels of each image. Referring next to FIGS. 10 to 12, the structure of data used in the 3D image comparison program, method, and device will be described below.

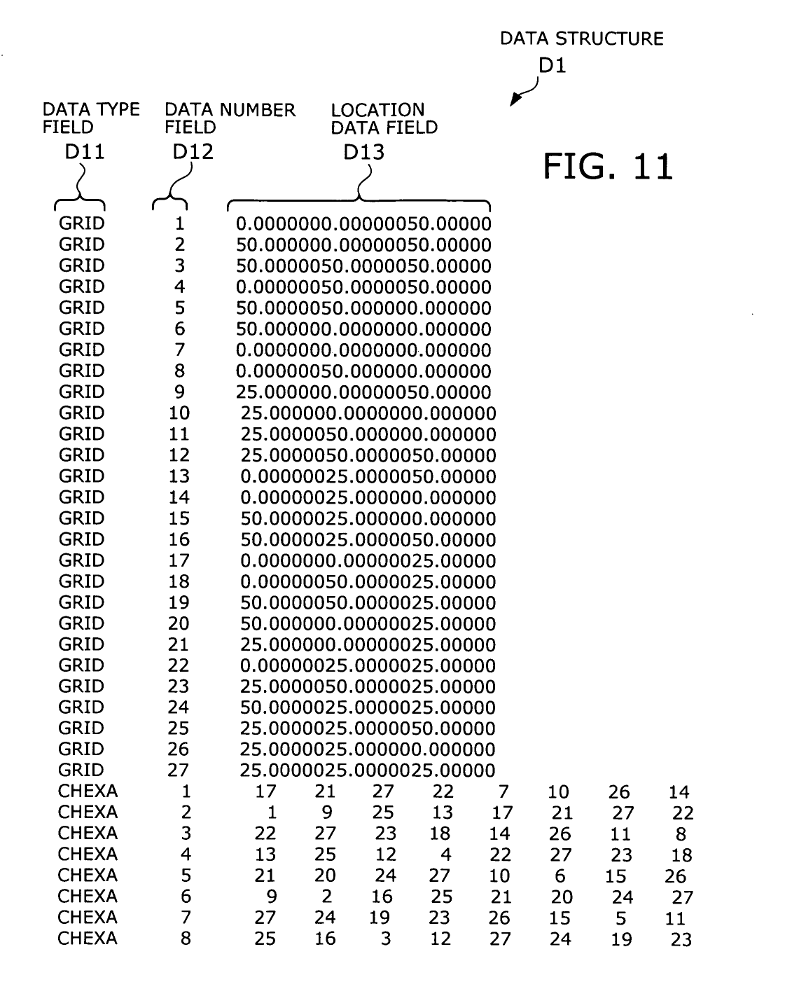

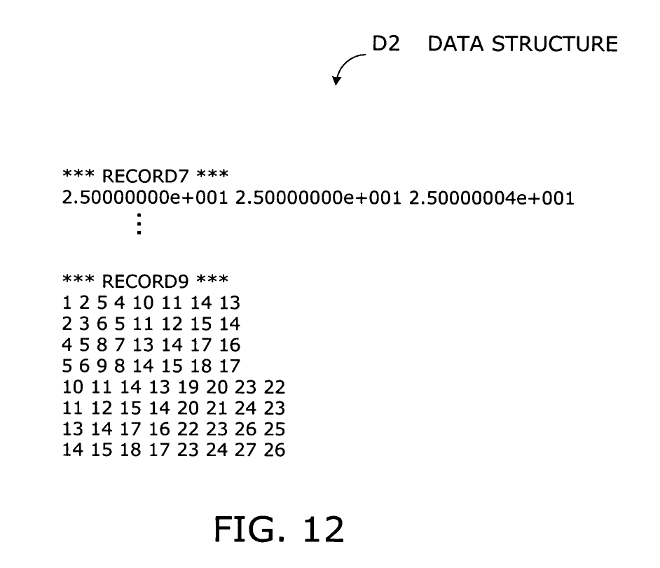

FIG. 10 shows the relationship between voxel element numbers and articulation point numbers. FIG. 10 assumes that a 3D image is converted to eight voxels Bx1 to Bx8. Voxel Bx1 is defined as a set of articulation points (1, 2, 5, 4, 10 11, 14, 13), where the points is ordered counterclockwise, first on the bottom plane and then on the top plane. The voxel data structure contains coordinate data for each of such articulation points. Referring now to FIGS. 11 and 12, the following will describe this coordinate data in detail.

FIG. 11 shows a typical data structure representing articulation points of a 3D image, which is, more particularly, a typical data structure used in a finite element analysis. Voxel data structure D1 of FIG. 11 is formed from a data type field D11 representing classification of data, a data number field D12 giving serial numbers in each data type, and a location data field D13 providing location data for each data type.

The data type field D11 contains symbols such as “GRID” and “CHEXA” as shown in FIG. 11. “GRID” refers to articulation points, and “CHEXA” refers to segments constituting a 3D image.

The data number field D12 contains serial numbers. For example, GRID entries are serially numbered, from “1” to “27,” as FIG. 11 shows. These serial numbers correspond to what have been mentioned in FIG. 10 as articulation point numbers. The data number field D12 also contains serial numbers “1” to “8” for CHEXA entries shown in FIG. 11. These serial numbers “1” to “8” are what have been mentioned in FIG. 10 as voxel element numbers.

The location data field D13 contains the coordinates of each articulation point, such as “0.000000, 0.000000, 50.00000” for the GRID entry numbered “1,” as shown in FIG. 11. Each data number (referred to as “articulation point ID” for GRID entries) is followed by coordinates (x, y, z) in floating-point notation. FIG. 11 shows other entries of the same data type.

The location data field D13 further contains articulation point IDs of each CHEXA entry, such as “17, 21, 27, 22, 7, 10, 26, 14” for the entry numbered “1.” That is, each CHEXA entry is defined as a data number (referred to as “element ID”) accompanied by such a series of articulation point IDs. FIG. 11 also shows other similar entries.

FIG. 12 shows a data structure of voxels using articulation points, which enables a 3D image space to be represented in the voxel domain. As seen, the data structure D2 defines voxels in two separate records that are previously defined, one containing element sizes and the other containing articulation points of each element. Element sizes are represented by the lengths of x, y, and z edges in floating-point form. Each element is defined as a series of articulation points. The illustrated data structure, however, has no particular record for element IDs because those element definitions are arranged in an orderly sequence. In the example of FIG. 12, RECORD7 defines the element size as “2.50000000e+001, 2.50000000e+001, 2.50000004e+001” in the scientific notation (floating-point notation). Also, RECORD9 contains articulation points “1, 2, 5, 4, 10, 11, 14, 13” to “14 15, 18, 17, 23, 24, 27, 26” to define multiple elements. In the notation of element sizes, the symbol e represents the base of exponentiation. In the above example, e is 10, as in e+001=10.

3D images are compared with a 3D image comparison device with the above-described structure. The following will explain in detail what the 3D image comparison process actually performs.

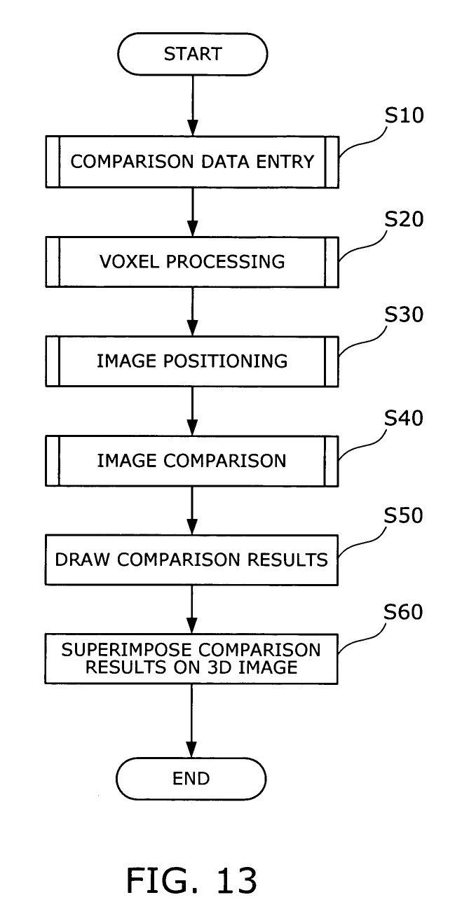

FIG. 13 is a flowchart showing the entire process flow of 3D image comparison. This process is executed by the CPU 101 upon power-up of the 3D image comparison device, upon activation of a relevant program, or in response to other predetermined events. The following will describe the flowchart of FIG. 13 in the order of step numbers, with reference to the functions explained earlier in FIG. 4.

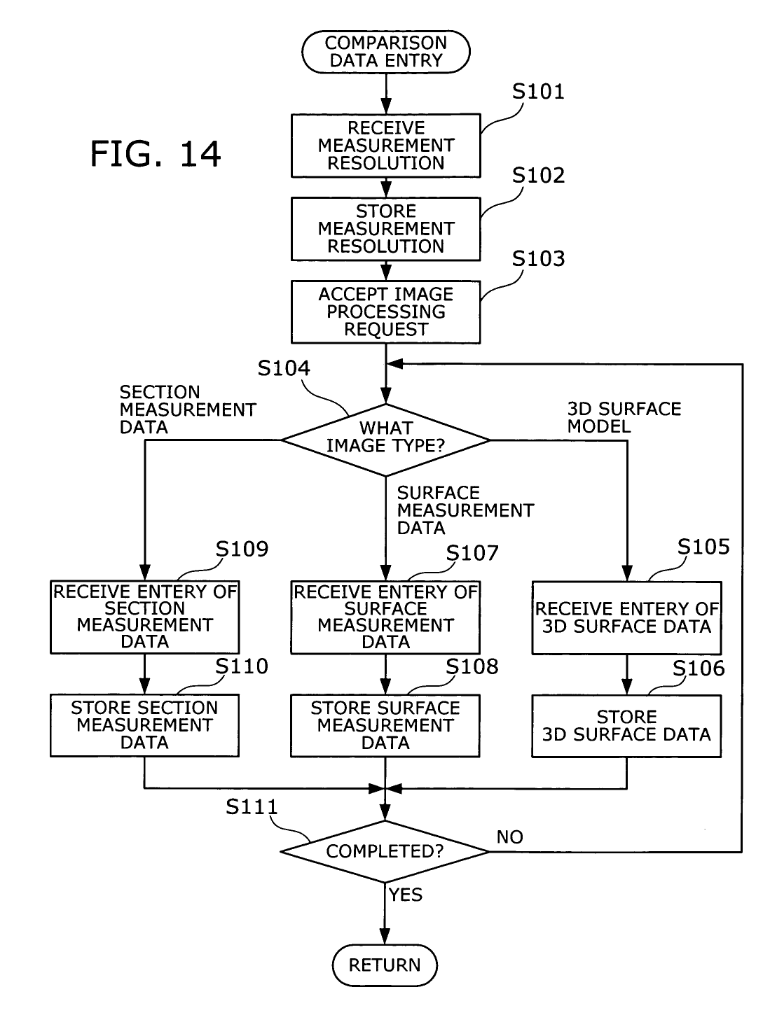

(Step S10) The comparison data entry unit 10 performs a comparison data entry process to input CAD data and measurement data, which are 3D images to be compared. Details of this comparison data entry process will be described later with reference to FIG. 14.

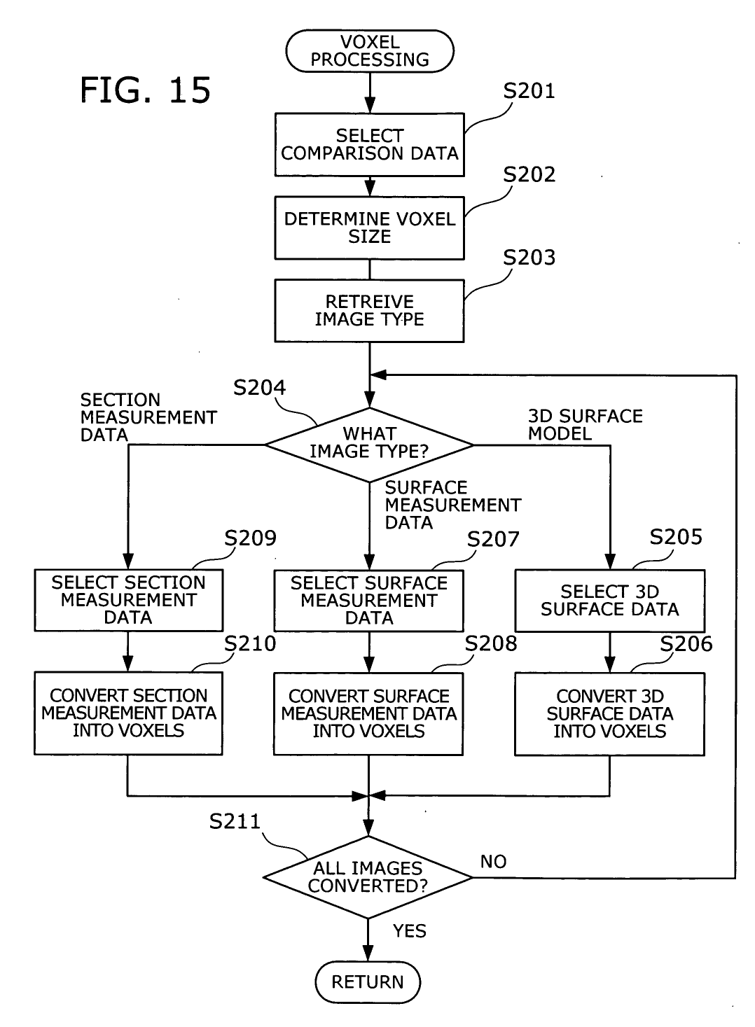

(Step S20) The voxel processor 20 performs voxel processing on the 3D images given at step S10 to generate images in voxel form. Details of this voxel processing will be described later with reference to FIG. 15.

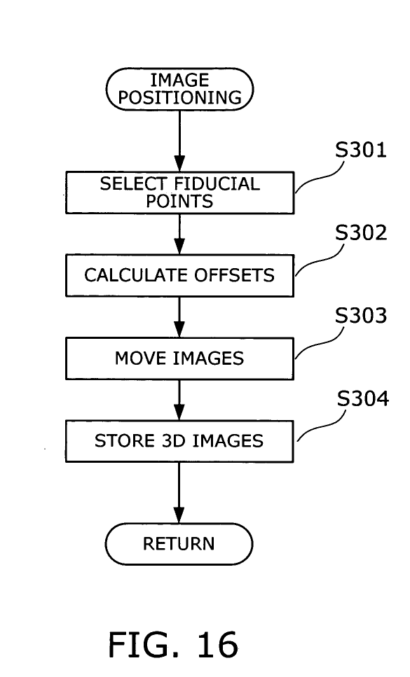

(Step S30) With the two images converted into voxel form at step S20, the image positioning processor 30 performs an image positioning process to align the two images properly. Details of this image positioning process will be described later with reference to FIG. 16.

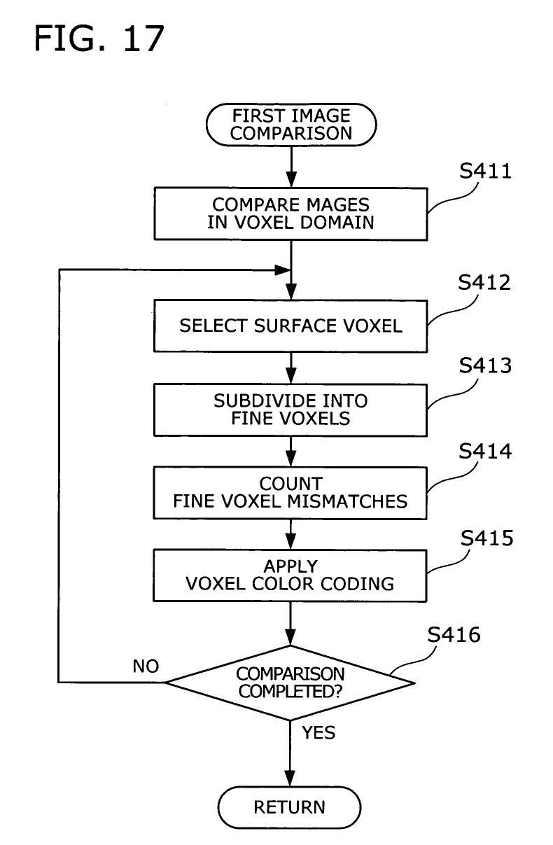

(Step S40) The voxel difference evaluator 40 executes an image comparison process to compare and evaluate the two images that has been aligned properly at step S30. Details of this image comparison process will be described later with reference to FIG. 17.

(Step S50) The voxel difference evaluator 40 draws, in a particular representation scheme, a plurality of images produced at the comparison and evaluation step S40. The term “particular representation scheme” refers herein to a technique of representing image differences by using, for example, RGB colors with different depths.

(Step S60) The voxel overlaying processor 50 aligns and combines the plurality of images shown at step S50, thereby overlaying comparison results on a specified 3D image. More specifically, a 3D differential image is obtained from a comparison between two voxel-converted images, with exclusive-OR operations to selectively visualize a mismatched portion of them. In this case, the voxel overlaying processor 50 can display the original images and their mismatched portions distinguishably by using different colors. This is accomplished through superimposition of the two voxel-converted images, 3D differential image, and/or 3D fine differential image.

FIG. 14 is a flowchart of a comparison data entry process as part of the 3D image comparison process of FIG. 13. Step S10 (comparison data entry process) of FIG. 13 calls up the following sequence of steps. This comparison data entry process is performed by the comparison data entry unit 10 of the 3D image comparison device.

(Step S101) The measurement resolution entry unit 11 in the comparison data entry unit 10 receives input of measurement resolution from the user.

(Step S102) The measurement resolution memory 12 stores the measurement resolution parameter received at step S101.

(Step S103) The comparison data entry unit 10 receives a 3D image entry command from the user.

(Step S104) The comparison data entry unit 10 determines of what image type the 3D image specified at step S103 is. The comparison data entry unit 10 then proceeds to step S105 if the image type is “3D surface model,” or to step S107 if it is “surface measurement data,” or to S109 if it is “section measurement data.” In the case the image type is either “surface measurement data” or “section measurement data,” the point set process switch 15 activates a surface point set entry unit 16 or volume point set entry unit 18, accordingly.

(Step S105) Since the image type identified at step S104 is “3D surface model,” the 3D surface entry unit 13 in the comparison data entry unit 10 receives a 3D surface entry from a 3D CAD image file DB11.

(Step S106) The image memory 14 stores the 3D surface received at step S105 in its internal storage device.

(Step S107) Since the image type identified at step S104 is “surface measurement data,” the surface point set entry unit 16 receives a surface measurement data entry from a 3D measured image file DB12.

(Step S108) The surface point set memory 17 stores the surface measurement data received at step S107 in its internal storage device.

(Step S109) Since the image type identified at step S104 is “section measurement data,” the volume point set entry unit 18 receives a section measurement data entry from a 3D measured image file DB12.

(Step S110) The volume point set memory 19 stores the section measurement data received at step S109 in its internal storage device.

(Step S111) The comparison data entry unit 10 determines whether all necessary 3D images have been stored at steps S106, S108, and S110. If more 3D images are needed, then comparison data entry unit 10 goes back to step S104 to repeat another cycle of processing in a similar fashion. If a sufficient number of 3D images are ready, the comparison data entry unit 10 exits from the present process, thus returning to step S10 of FIG. 13.

FIG. 15 is a flowchart of voxel processing as part of the 3D image comparison process of FIG. 13. Step S20 (voxel processing) of FIG. 13 calls up the following sequence of steps. This voxel processing is performed by the voxel processor 20 in the 3D image comparison device.

(Step S201) The voxel processor 20 selects the comparison data stored at step S10.

(Step S202) Based on the measurement resolution received and stored at step S10, the voxel processor 20 determines voxel size.

(Step S203) The voxel processor 20 is supplied with the types of 3D images stored at step S10.

(Step S204) The voxel processor 20 determines which image type has been supplied at step S203. The voxel processor 20 then proceeds to step S205 if the image type is “3D surface model,” or to step S207 if it is “surface measurement data,” or to S209 if it is “section measurement data.”

(Step S205) Since the image type identified at step S204 is “3D surface model,” the voxel processor 20 selects and reads 3D surface data from the image memory 14 and delivers it to the first voxel generator 21.

(Step S206) With the 3D surface data delivered at step S205, the first voxel generator 21 in the voxel processor 20 produces a 3D image in voxel form.

(Step S207) Since the image type identified at step S204 is “surface measurement data,” the second voxel processor 20 selects and reads surface measurement data from the surface point set memory 17 and delivers it to the second voxel generator 22.

(Step S208) With the surface measurement data delivered at step S207, the second voxel generator 22 in the voxel processor 20 creates a 3D image in voxel form.

(Step S209) Since the image type identified at step S204 is section measurement data, the voxel processor 20 selects and reads section measurement data from the volume point set memory 19 and delivers it to the voxel generator 22.

(Step S210) With the section measurement data delivered at step S209, the second voxel generator 22 in the voxel processor 20 creates a 3D image in voxel form.

(Step S211) The voxel processor 20 determines whether all required 3D images have been created at steps S206, S208, and/or S210. If more 3D images are needed, then voxel processor 20 goes back to step S204 to repeat another cycle of processing in a similar fashion. If all required 3D images are ready, the voxel processor 20 exits from the present process, thus returning to step S20 of FIG. 13.

FIG. 16 is a flowchart of an image positioning process as part of the 3D image comparison process of FIG. 13. Step S30 (image positioning process) of FIG. 13 calls up the following sequence of steps. This image positioning process is performed by an image positioning processor 30 in the 3D image comparison device.

(Step S301) The image positioning processor 30 selects predefined fiducial points of two 3D images. One of the two 3D images is CAD data of a 3D surface model, and the other is surface measurement data or section measurement data obtained through measurement.

(Step S302) The image positioning processor 30 calculates the offsets of images from the fiducial points selected at step S301.

(Step S303) Based on the offsets calculated at step S302, the image positioning processor 30 moves the voxel-converted 3D images.

(Step S304) The image positioning processor 30 stores the 3D images moved at step S303 in its internal storage space. It then exits from the current process, thus returning to the step S30 of FIG. 13.

The following will describe the 3D image comparison process of the present invention. It has to be noted first that this 3D image comparison process is provided in several different versions for first to third embodiments of the invention. The version for the first embodiment is now referred to as the first image comparison process.

FIG. 17 is a flowchart of the first image comparison process as part of the 3D image comparison process of FIG. 13. Step S40 (image comparison process) of FIG. 13 calls up the following sequence of steps. This first image comparison process is executed by the voxel difference evaluator 40 of the proposed 3D image comparison device.

(Step S411) The voxel difference evaluator 40 produces a 3D differential image by comparing given two 3D images in the voxel domain.

(Step S412) The voxel difference evaluator 40 selects a surface voxel of the 3D differential image. This selection can easily be made, since a surface voxel adjoins a voxel being set to OFF state while some other surrounding voxels are set to ON state.

(Step S413) Now that a surface voxel is selected at step S412, the voxel difference evaluator 40 performs an additional voxel conversion at a given test resolution. That is, the selected surface voxel is subdivided into fine voxels at a higher resolution than that of the 3D differential image. The resulting 3D fine differential image contains fine-voxel images that provides details of the original 3D images (i.e., 3D surface model and surface/section measurement data) in the surface voxel that is selected.

(Step S414) The voxel difference evaluator 40 counts fine-voxel mismatches found in the (coarse) surface voxel.

(Step S415) Based on the number of mismatches counted at step S414, the voxel difference evaluator 40 determines a color as a representation scheme for the selected surface voxel.

(Step S416) The voxel difference evaluator 40 determines whether all surface voxels are colored. In other words, the voxel difference evaluator 40 determines whether the voxel-converted 3D images are completely compared. If there are still uncolored surface voxels, the voxel difference evaluator 40 returns the step S412 to repeat a similar process. If all surface voxels are colored, the voxel difference evaluator 40 exits from the present process and returns to step S40 of FIG. 13.

As can be seen from the above description, according to the first embodiment of the invention, the computer first converts 3D images B21 and B22 into voxel form and compares them to create a 3D differential image VB21. With respect to a surface voxel of the 3D differential image VB21, the computer produces a 3D fine differential image VB22 containing fine-voxel images that provides details of the original two 3D images B21 and B22 at a higher resolution than in the initial comparison. Subsequently, the computer determines a representation scheme for visualizing a dissimilar part of the 3D differential image VB21, based on detailed differences between the 3D images B21 and B22. In this step, the color of a surface voxel is determined from the number of mismatches found in that voxel. After processing all surface voxels in this way, the computer then outputs voxel comparison results on a display screen or the like by drawing the 3D differential image VB21, including surface voxels depicted in their respective colors.

The present invention enables given 3D images to be compared more quickly and accurately. The proposed comparison process handles images as a limited number of 3D voxels, rather than a set of countless points, thus making it possible to improve memory resource usage and reduce the number of computational cycles. A significant reduction of computational cycles can be achieved by omitting comparison of voxels other than those on the surface.

Thus far the explanation has assumed that the comparison process creates and evaluates fine-voxel images for all surface voxels of a 3D differential image. However, it is also possible to create and evaluate fine-voxel images only for such surface voxels that exhibit a mismatch. In this case, step S412 of FIG. 17 will include the substeps of determining whether the selected surface voxel is flagged as a mismatch and finding another one if it is not.

### Second Embodiment

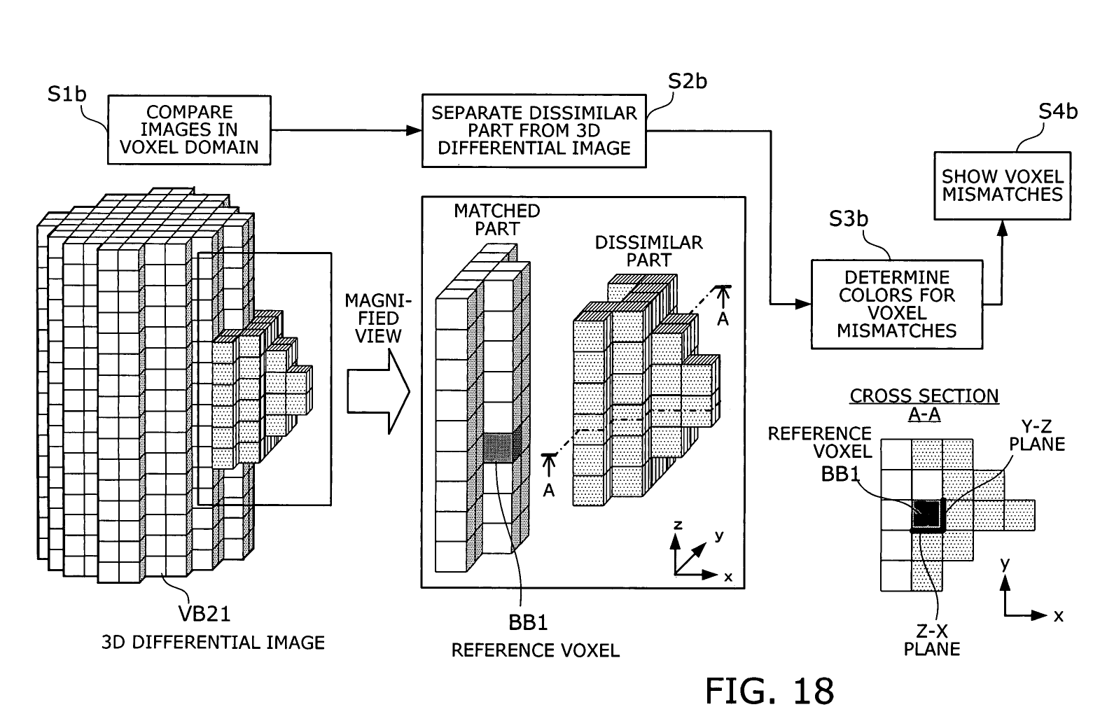

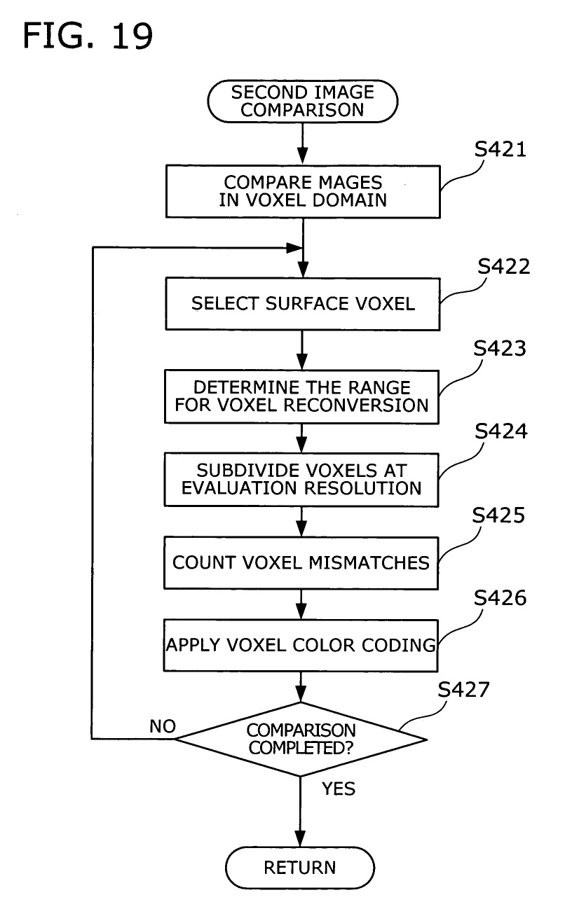

This section describes a second embodiment of the invention, which differs from the first embodiment in how a comparison is implemented. Specifically, according to the second embodiment, each surface of a reference voxel is displayed in a particular representation scheme that reflects the thickness of a dissimilar layer of voxels on that voxel surface after the 3D images are compared in the voxel domain. Referring now to FIGS. 18 and 19, the following will describe the second embodiment in detail.

FIG. 18 gives an overview of a comparison process performed with a 3D image comparison program according to the second embodiment. The comparison process starts with creating voxels in the same way as in the first embodiment, and it then assigns a particular color to each surface of voxels in one 3D image to visualize its differences from the other. As will be described in detail below, the color is determined in accordance with the number of voxel mismatches counted perpendicularly, or in the thickness direction, from each surface of matched voxels.

Referring to FIG. 18, given 3D images are compared in voxel form, and creates a 3D differential image VB21 in the same way as in the first embodiment (step S1b). A dissimilar part is discovered and separated from the 3D differential image VB21 (step S2b). As a result, an outermost layer of matched voxels appears under the removed dissimilar part. One of such matched voxels is then designated as a reference voxel BB1, and the number of voxel mismatches is counted in the direction perpendicular to each 3D geometric surface (z-y plane, z-x plane, y-x plane) of the reference voxel BB1. Based on the resultant count values (i.e., the thickness of a dissimilar layer of voxels), a representation scheme for visualizing that dissimilar part is determined (step S3b). More specifically, think of y-z and z-x planes in the illustrated cross section A-A, for example. The mismatch is evaluated in this case as three voxels on the y-z plane and two voxels on the z-x plane. Representation schemes for reference voxel surfaces are determined from those count values. Each surface of the reference voxel is displayed in the determined representation schemes (step S4b). Such representation schemes include color designations in RGB or CMY format mentioned earlier.

As can be seen from the above description, the proposed 3D image comparison program causes a computer to compare given 3D images in the voxel domain in the same way as in the first embodiment. It separates a dissimilar part from the resulting 3D differential image VB21, thus permitting an outermost layer of matched voxels to appear. Then the computer selects a voxel BB1 (reference voxel) from that layer and counts voxel mismatches perpendicularly from each 3D geometric surface (z-y plane, z-x plane, y-x plane) of the selected reference voxel BB1. The voxel mismatch count means the thickness of a dissimilar part, and based on that count, the computer determines a representation scheme for depicting the corresponding reference voxel surface. The computer renders each surface of the reference voxel in the determined representation scheme.

The functions explained in the above overview can be implemented in what are shown in the functional block diagram of FIG. 4, except for the voxel difference evaluator 40. Accordingly, the following explanation of the second embodiment will focus on the additional functions of the voxel difference evaluator 40 (although it may include what have already been explained).

In the above overview, the reference voxel has been explained as a matched surface voxel that adjoins a dissimilar part of the images under test. The following explanation, however, will use the same term to refer to one of fine voxels that are produced by reconverting a range of coarse voxels at a given test resolution.

According to the second embodiment of the invention, the voxel difference evaluator 40 compares two images that have been properly positioned by the image positioning processor 30. The voxel difference evaluator 40 selects a surface voxel of the resulting 3D differential image. If this surface voxel indicates a mismatch of the 3D images under test, then the voxel difference evaluator 40 determines which range of voxels to reconvert. That is, it identifies a range containing an image mismatch for more detailed comparison.

Within that determined range, the voxel difference evaluator 40 performs an additional voxel conversion at a given test resolution. That is, voxels in the determined range are subdivided into fine voxels according to a given test resolution. The voxel difference evaluator 40 then counts fine voxel mismatches by examining the 3D surface model and surface/section measurement data now in the form of fine voxels. More specifically, an outermost fine voxel of a matched part of the compared images is designated as a reference voxel, and the number of voxel mismatches (i.e., the thickness of a dissimilar part) is counted in each direction perpendicular to different 3D geometric surfaces (e.g., z-y, z-x, and y-x planes) of that voxel.

Based on the resulting voxel mismatch counts, the voxel difference evaluator 40 determines color depths as representation schemes, so that the surfaces will be colored. That is, the voxel difference evaluator 40 assigns a particular representation scheme (color) to each surface of the reference voxel, which is a fine voxel belonging to a matched part of the compared images. The voxel difference evaluator 40 repeats the above until the voxel-converted 3D images are completely compared.

Referring next to FIG. 19, the following will provide more specifics about the comparison process implemented in a 3D image comparison program according to the second embodiment of the invention. As mentioned earlier, the first to third embodiments of the invention use their respective versions of the 3D image comparison process. The version for the second embodiment is now referred to as the second image comparison process.

FIG. 19 is a flowchart of the second image comparison process as part of the 3D image comparison process of FIG. 13. Step 40 (image comparison process) of FIG. 13 calls up the following sequence of steps. This second image comparison process is executed by the voxel difference evaluator 40 of the proposed 3D image comparison device. Note that the flowchart of FIG. 19 includes reconversion of a range of coarse voxels.

(Step S421) The voxel difference evaluator 40 produces a 3D differential image by comparing given two 3D images in the voxel domain.

(Step S422) The voxel difference evaluator 40 selects a surface voxel. This selection can easily be made, since a surface voxel of a voxel-converted 3D image adjoins a voxel being set to OFF state while some other surrounding voxels are set to ON state.

(Step S423) Now that a surface voxel is selected at step S422, the voxel difference evaluator 40 determines what range of voxels need an additional conversion. That is, it identifies a range of voxels surrounding an image mismatch, if any, for the purpose of more detailed comparison.

(Step S424) Within the range determined at step S423, the voxel difference evaluator 40 performs an additional voxel conversion at a given test resolution. Voxels in the determined range are thus subdivided into fine voxels according to a given test resolution.

(Step S425) The voxel difference evaluator 40 compares the reconverted 3D surface model and surface/section measurement data and counts their voxel mismatches. More specifically, an outermost fine voxel of a matched part of images in the reconversion range is designated as a reference voxel, and the number of fine voxel mismatches is counted in each direction perpendicular to different 3D geometric surfaces (e.g., z-y plane, z-x plane, y-x plane) of that voxel. The resulting mismatch counts indicate the thicknesses of the dissimilar part measured in different directions.

(Step S426) Based on the voxel mismatch counts obtained at step S425, the voxel difference evaluator 40 determines color depths, so that voxel surfaces will be colored. That is, the voxel difference evaluator 40 assigns a particular representation scheme (color) to each surface of the reference voxel, which is a fine voxel belonging to a matched part of the compared images.

(Step S427) The voxel difference evaluator 40 determines whether the voxel-converted 3D images are completely evaluated. If there are still uncolored voxels, the voxel difference evaluator 40 returns the step S422 to repeat a similar process. If all voxels are colored, the voxel difference evaluator 40 exits from the present process and returns to step S40 of FIG. 13.

As can be seen from the above, the comparison process according to the second embodiment visualizes the difference with colors assigned on each surface of a 3D object, rather than drawing voxels with some depth, in order to reduce the consumption of computational resources (e.g., memory capacity, disk area, computation time). Actually, the proposed technique reduces resource consumption to a few tenths.

The depth of a color representing a mismatch is proportional to the thickness of a dissimilar layer of voxels. The color depth of each voxel surface is normalized with respect to the maximum depth of all colors assigned.

As mentioned earlier, a matched voxel immediately adjoining a dissimilar part is selected as a reference voxel. When the comparison process does not include reconversion of voxels (as in the case shown in FIG. 18), the reference voxel is as large as other voxels constituting a 3D differential image. When the comparison process involves reconversion of voxels (as in the case discussed in FIG. 19), the reference voxel is a fine voxel selected from among those produced by subdividing voxels in a range that contains a dissimilar part.

### Third Embodiment

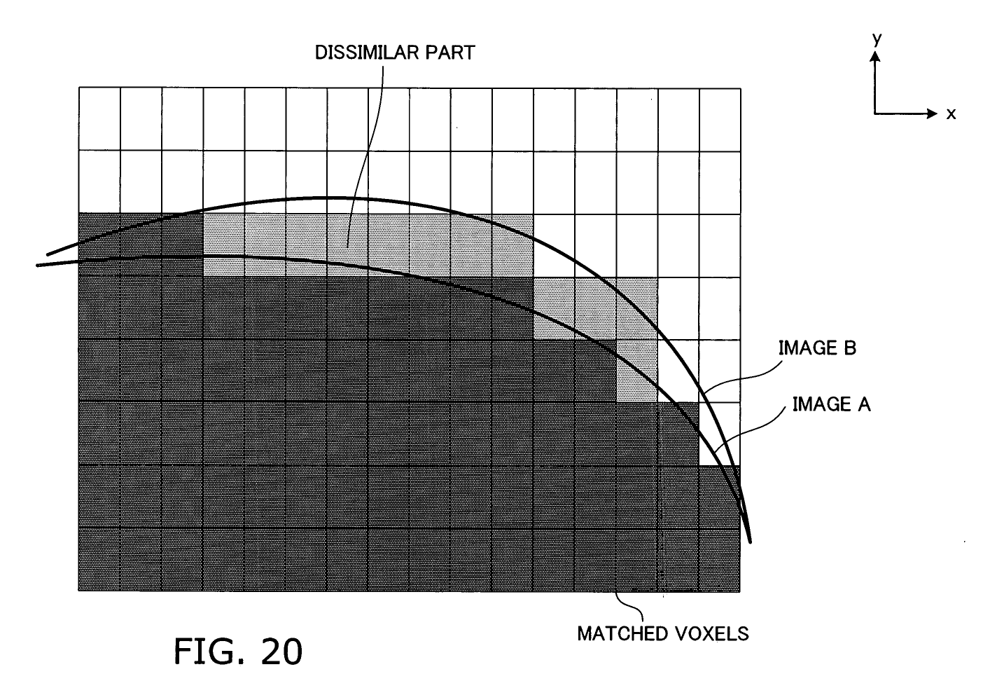

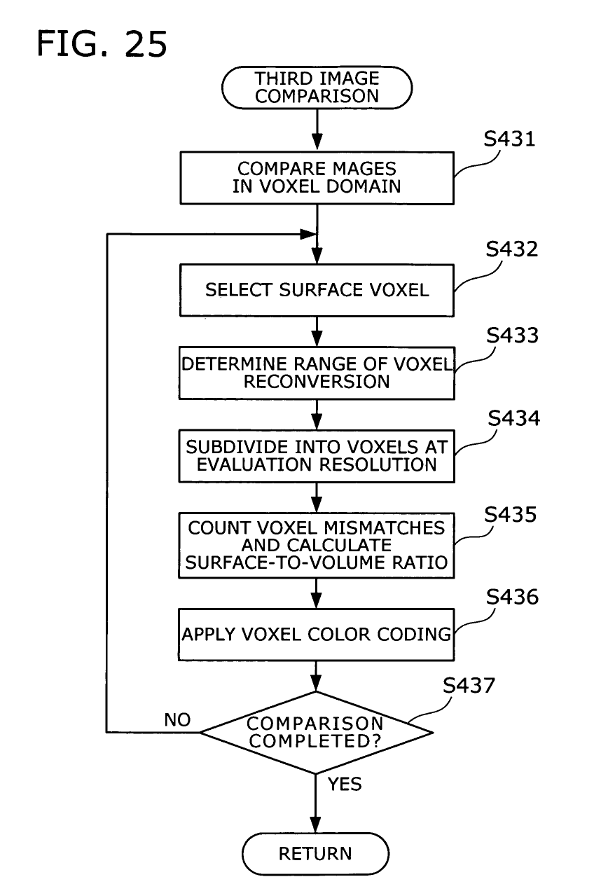

This section describes a third embodiment of the invention, which differs from the first embodiment in how a comparison is implemented. Specifically, the third embodiment compares 3D images on an individual voxel basis, counts all surface voxels that constitute a dissimilar part of the images, calculates the volume of that dissimilar part, and displays those voxels using an appropriate representation scheme that reflects the ratio of the number of surface voxels to the volume. Referring now to FIGS. 20 and 25, the following will describe in detail the third embodiment.

FIG. 20 shows a first example of a difference that is evaluated by a 3D image comparison program according to a third embodiment of the invention. The illustrated difference between two images A and B is identified as a dissimilar part of voxels produced in the same way as in the first embodiment. Such a dissimilar part, or “island,” consists of one or more voxels, and the comparison method of the third embodiment gives each island a particular color that represents a ratio of surface voxels of that island to the total number of voxels forming that island. The following will provide more specifics about how to determine a color for each island, or each dissimilar part of images under test.

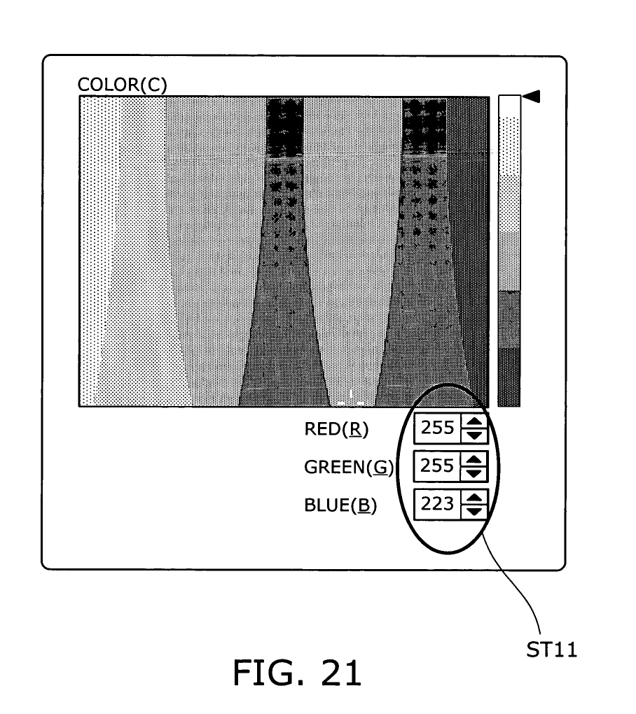

Referring to FIG. 20, two 3D images A and B are converted into voxel form and compared in the same way as in the first embodiment. The comparison method of the third embodiment quantifies the dissimilarity in the following way:
Volume: 12 voxels
Surface area (Y direction): 25 voxel surfaces
   The ratio of surface voxels to total voxels is 25/12 in this case, which indicates that the dissimilar part of interest is relatively thin. A particular color (e.g., a light color) is set to such a surface-to-volume ratio, as shown in FIG. 21.

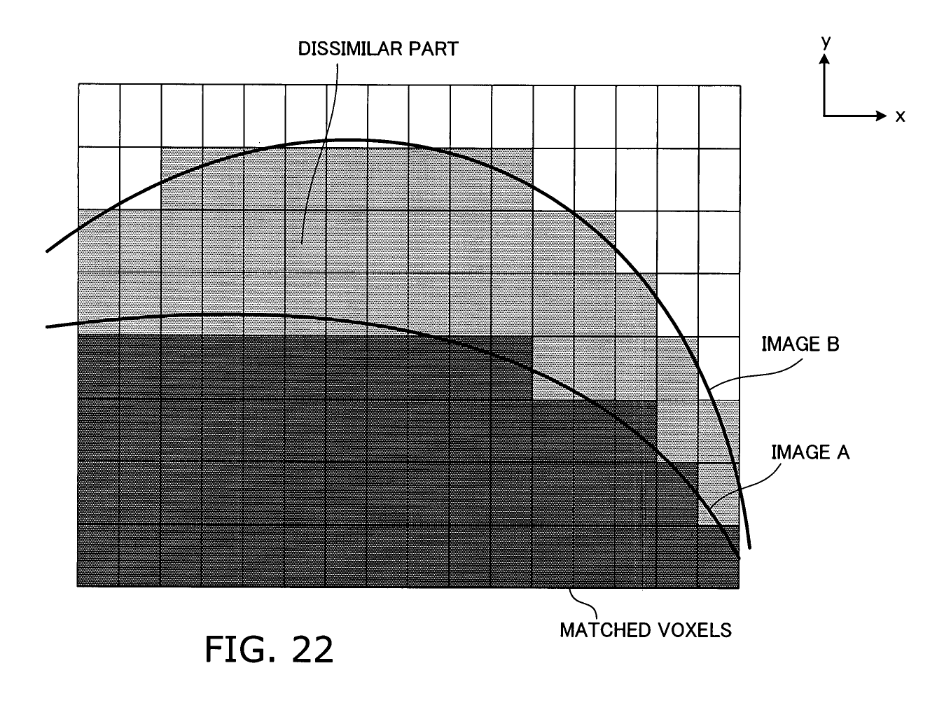

Generally a color representing a dissimilarity of images is specified in the RGB domain. In the example of FIG. 21, the intensity of blue (B) is modified to express the degree of dissimilarity. The control boxes in area ST11 are set to (255(R), 255(G), 223(B)) to indicate the presence of a thin layer of voxel mismatches on a certain portion of the surface. Particularly, the value of 223(B) gives a light color, which indicates that the dissimilar part is a thin layer. If the blue level was set to, for example, 96(B), it would indicate the presence of a thick layer of voxel mismatches as a dissimilar part of images. The following will discuss more about this case, with reference to FIG. 22.

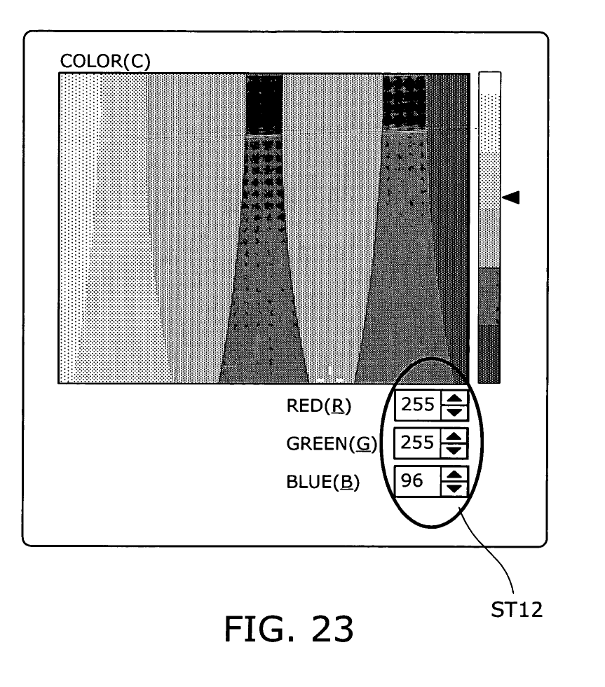

FIG. 22 shows a second example of a difference that is evaluated by the 3D image comparison program of the third embodiment, and particularly the case where the mismatch is greater than the one explained in FIG. 20. Referring to FIG. 22, two voxel-converted 3D images A and B are compared in the same way as in the first embodiment. The comparison method of the third embodiment quantifies the dissimilarity in the following way:
Volume: 43 voxels.
Surface area (Y direction): 32 voxel surfaces
   The ratio of surface voxels to total voxels is 32/43 in this case, which indicates that the dissimilar part of interest is relatively thick. Another particular color is set to such a surface-to-volume ratio, as shown in FIG. 23.

FIG. 23 shows a deep color determined by the 3D image comparison program of the third embodiment. Generally a color representing a dissimilarity of images is specified in the RGB domain. In the example of FIG. 23, the intensity of blue (B) is modified to express the degree of dissimilarity. The control boxes in area ST12 are set to (255(R), 255(G), 96(B)) to indicate the presence of a thick layer of voxel mismatches on a certain portion of the surface. Particularly, the value of 96(B) gives a deep color, which indicates that the dissimilar part is a thick layer.

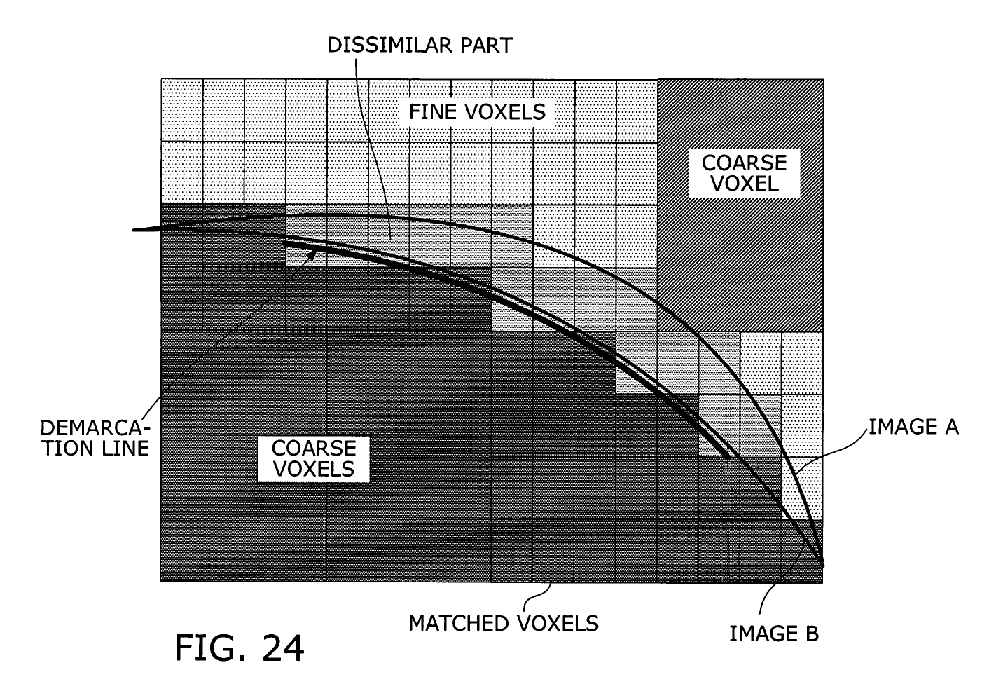

If a mismatch is found, that portion is subdivided into fine voxels for further evaluation, and a chunk of mismatched fine voxels is then colored uniformly. Such a colored area on the compared 3D surface is saved as a partial surface. An example of this difference evaluation is shown in FIG. 24.

FIG. 24 shows a third example of a difference that is evaluated by the 3D image comparison program of the third embodiment. In FIG. 24, all coarse voxels containing a mismatch are subdivided into fine voxels for detailed comparison. The boldest line is a demarcation line that separates the discovered dissimilar part from other voxels. Actually, what FIG. 24 shows is a result of a fine voxel comparison made with the voxels shown in FIG. 20. This detailed comparison is similar to what have been explained in FIGS. 20 and 22, and that explanation is not repeated here.

The functions explained in the above overview can be implemented in what are shown in the functional block diagram of FIG. 4, except for the voxel difference evaluator 40. Accordingly, the following explanation of the third embodiment will focus on the additional functions of the voxel difference evaluator 40 (although it may include what have already been explained).

According to the third embodiment of the invention, the voxel difference evaluator 40 compares two images that have been properly positioned by the image positioning processor 30. The voxel difference evaluator 40 selects a surface voxel of the resulting 3D differential image. If this surface voxel indicates a mismatch of the 3D images under test, then the voxel difference evaluator 40 determines which range of voxels to reconvert. That is, it identifies a range containing an image mismatch for more detailed comparison.

Within that determined range, the voxel difference evaluator 40 performs an additional voxel conversion at a given test resolution. That is, voxels in the determined range are subdivided into fine voxels according to a given test resolution. Subsequently, the voxel difference evaluator 40 then counts mismatches by examining the 3D surface and surface/section measurement data now in the form of fine voxels. It then calculates the ratio of surface voxels to total voxels for each dissimilar part of the 3D differential image.

Based on the calculated ratio, the voxel difference evaluator 40 determines a color depth as a representation scheme, so that relevant voxels will be colored. That is, the voxel difference evaluator 40 determines a representation scheme (i.e., color) for every dissimilar part consisting of voxels flagged as being a mismatch. The voxel difference evaluator 40 repeats the above until the voxel-converted 3D images are completely compared.

Referring next to FIG. 25, the following will provide more specifics about the comparison process implemented in a 3D image comparison program according to the third embodiment of the invention. As mentioned earlier, the first to third embodiments of the invention use their respective versions of the 3D image comparison process. The version for the third embodiment is now referred to as the second image comparison process.

FIG. 25 is a flowchart of a third image comparison process as part of the 3D image comparison process of FIG. 13. Step 40 (image comparison process) of FIG. 13 calls up the following sequence of steps. This third image comparison process is executed by the voxel difference evaluator 40 of the proposed 3D image comparison device.

(Step S431) The voxel difference evaluator 40 produces a 3D differential image by comparing given two 3D images in the voxel domain.

(Step S432) The voxel difference evaluator 40 selects a surface voxel. This selection can easily be made, since a surface voxel of a voxel-converted 3D image adjoins a voxel being set to OFF state while some other surrounding voxels are set to ON state.

(Step S433) Now that a surface voxel is selected at step S432, the voxel difference evaluator 40 determines what range of voxels need an additional conversion. That is, it identifies a range of voxels surrounding an image mismatch, if any, for the purpose of more detailed comparison.

(Step S434) Within the range determined at step S433, the voxel difference evaluator 40 performs an additional voxel conversion at a given test resolution. Voxels in the determined range are thus subdivided into fine voxels according to a given test resolution.

(Step S435) The voxel difference evaluator 40 compares the reconverted 3D surface and surface/section measurement data and counts their voxel mismatches. It then calculates the ratio of surface voxels to total voxels for each dissimilar part of the 3D differential image.

(Step S436) Based on the calculated ratio of voxel mismatches, the voxel difference evaluator 40 determines a color depth, so that relevant voxels will be colored. That is, the voxel difference evaluator 40 determines a representation scheme (i.e., color) for every dissimilar part consisting of voxels flagged as being a mismatch.

(Step S437) The voxel difference evaluator 40 determines whether the voxel-converted 3D images are completely evaluated. If there are still uncolored voxels, the voxel difference evaluator 40 returns the step S432 to repeat a similar process. If all voxels are colored, the voxel difference evaluator 40 exits from the present process and returns to step S40 of FIG. 13.

As can be seen from the above, the comparison process according to the third embodiment visualizes differences between given 3D images by giving a particular color to each dissimilar part as a whole, rather than drawing voxels with some depth, in order to reduce the consumption of computational resources (e.g., memory capacity, disk area, computation time). Actually, the proposed technique reduces resource consumption to a few tenths.

The ratio of surface voxels to total voxels is in a range of zero, or nearly zero (more precisely), to two. Accordingly, a lightest color is assigned to the maximum ratio, and a deepest color to the minimum ratio. Note that the size of a dissimilar part is not reflected in the selection of colors since the user can see it from a 3D picture on the screen.

Computational Resource Usage in First Embodiment

In this section the usage of computational resources in the first embodiment will be discussed by way of example. The first embodiment of the invention offers the following advantages:
Significant reduction of computational burden, and consequent quick response
Detailed comparison with realistic amounts of computational resources (memory, disks, etc.)
Improved efficiency of comparison tasks

For example, computational resource usage is evaluated as follows. Recall the 3D surface model given by equation (1), and suppose that a conventional method is used to calculate minimum distances for many measurement points shown in Table (1). The amount of computation is then estimated, considering the following factors:
Finding a nearest point on a given surface segment takes several hundreds of floating point operations.
Calculation of a distance from that point to the measurement point of interest takes several tens of floating point operations.
For each measurement point, up to several tens of near surfaces segments should be examined.
   This means that several tens of thousands of floating point operations are required to calculate a minimum distance. Since this calculation is repeated ten billion times, the total computation time will be about 30 hours, assuming the use of a 1-GHz CPU capable of two simultaneous floating point operations per cycle.

In contrast to the above, the method according to the first embodiment of the invention would require only 50 billion floating point operations. This is because of its spatial simplification; the proposed method places a multiple-surface body in a computational space, divides the entire space into voxels with a given measurement resolution, and applies voxel-by-voxel logical operations. The estimated computation time is 25 seconds, under the assumption that the same computer is used.

As the above example demonstrates, the first embodiment of the present invention allows a considerable reduction of computation times, in comparison to conventional methods. Also, the proposed methods according to the first embodiment is comparable to conventional methods in terms of accuracy, since its entire computational space is divided into voxels as fine as the measurement resolution.

Program Products in Computer-readable Media

All the processes described so far can be implemented as computer programs. A computer system executes such programs to provide intended functions of the present invention. Program files are installed in a computer's hard disk drive or other local mass storage device, and they can be executed after being loaded to the main memory. Such computer programs are stored in a computer-readable medium for the purpose of storage and distribution.

Suitable computer-readable storage media include magnetic storage media, optical discs, magneto-optical storage media, and semiconductor memory devices. Magnetic storage media include hard disks, floppy disks (FD), ZIP (a type of magnetic disks from Iomega Corporation, USA), and magnetic tapes. Optical discs include digital versatile discs (DVD), DVD random access memory (DVD-RAM), compact disc read-only memory (CD-ROM), CD-Recordable (CD-R), and CD-Rewritable (CD-RW). Magneto-optical storage media include magneto-optical discs (MO). Semiconductor memory devices include flash memories.

Portable storage media, such as DVD and CD-ROM, are suitable for the distribution of program products. It is also possible to upload computer programs to a server computer for distribution to client computers over a network.

### Conclusion

The above explanations are summarized as follows. According to the first aspect of the present invention, two voxel-converted 3D images are compared, and a particular surface voxel identified in this comparison is subdivided for further comparison at a higher resolution. The comparison results are displayed in a representation scheme that is determined from the result of the second comparison. The proposed technique enables 3D images to be compared quickly and accurately.

According to the second aspect of the present invention, given 3D images are compared, and a representation scheme is determined from the number of voxel mismatches counted perpendicularly to each surface of a reference voxel. The comparison results are displayed in the determined representation scheme. This technique enables 3D images to be compared quickly and accurately.

According to the third aspect of the present invention, given 3D images are compared, and a representation scheme is determined from a surface-to-volume ratio of a dissimilar part of the 3D images under test. The comparison results are displayed in the determined representation scheme. This technique enables 3D images to be compared quickly and accurately.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A three-dimensional (3D) comparison program for comparing a first 3D image with a second 3D image and visualizing differences therebetween, the program causing a computer to perform the steps of:
(a) producing a 3D differential image by converting the first and second 3D images into voxel form and making a comparison therebetween;
(b) producing, with respect to a surface voxel of the 3D differential image, fine-voxel images that provide details of the first and second 3D images at a higher resolution than that of the 3D differential image;
(c) determining a representation scheme from differences between the first and second 3D images in the fine-voxel images thereof; and
(d) displaying the 3D differential image including the surface voxel drawn in the determined representation scheme.

2. The 3D image comparison program according to claim 1, wherein the representation scheme gives color-coded representation of differences between the first and second 3D images.

3. The 3D image comparison program according to claim 2, wherein the color-coded representation uses an additive mixture of three primary colors of light which include red, green, and blue.

4. The 3D image comparison program according to claim 2, wherein the color-coded representation uses a subtractive mixture of three complementary primary colors including cyan, magenta, and yellow.

5. The 3D image comparison program according to claim 4, wherein the subtractive mixture of colors further uses black in addition to the three complementary primary colors.

6. The 3D image comparison program according to claim 1, wherein the comparison at said step (a) is performed with Boolean operations of voxel data representing the first 3D image and second 3D image.

7. The 3D image comparison program according to claim 1, wherein said step (c) counts the number of voxel mismatches between the fine-voxel images of the first and second 3D images.

8. The 3D image comparison program according to claim 1, wherein the first 3D image is given as 3D surface data in CAD data form.

9. The 3D image comparison program according to claim 1, wherein the second 3D image is given as a set of points obtained through measurement of an object.

10. A three-dimensional (3D) comparison program for comparing a first 3D image with a second 3D image and displaying differences therebetween, the program causing a computer to perform the steps of:
(a) producing a 3D differential image by converting the first and second 3D images into voxel form and making a comparison therebetween;
(b) extracting a dissimilar part from the 3D differential image, thus permitting an outermost layer of matched voxels to appear;
(c) counting voxel mismatches perpendicularly from each surface of a reference voxel that is selected from the outermost layer of matched voxels, and determining a representation scheme for each surface of the reference voxel, based on the voxel mismatch count; and
(d) displaying each surface of the reference voxel in the corresponding representation scheme.

11. The 3D image comparison program according to claim 10, wherein the representation scheme gives color-coded representation of differences between the first and second 3D images.

12. The 3D image comparison program according to claim 11, wherein the color-coded representation uses an additive mixture of three primary colors of light which include red, green, and blue.

13. The 3D image comparison program according to claim 11, wherein the color-coded representation uses a subtractive mixture of three complementary primary colors including cyan, magenta, and yellow.

14. The 3D image comparison program according to claim 13, wherein the subtractive mixture of colors further uses black in addition to the three complementary primary colors.

15. The 3D image comparison program according to claim 10, wherein said step (d) displays the 3D differential image excluding voxels in the dissimilar part.

16. The 3D image comparison program according to claim 10, wherein the first 3D image is given as 3D surface data in CAD data form.

17. The 3D image comparison program according to claim 10, wherein the second 3D image is given as a set of points obtained through measurement of an object.

18. A three-dimensional (3D) comparison program for comparing a first 3D image with a second 3D image and displaying differences therebetween, the program causing a computer to perform the steps of:
(a) producing a 3D differential image by converting the first and second 3D images into voxel form and making a comparison therebetween;
(b) calculating a ratio of the number of surface voxels of a dissimilar part of the 3D differential image to the total number of voxels constituting the dissimilar part, and based on the ratio, determining a representation scheme for visualizing voxel mismatches on the 3D differential image; and
(c) displaying the dissimilar part of the 3D differential image in the representation scheme determined from the ratio.

19. The 3D image comparison program according to claim 18, wherein the representation scheme gives color-coded representation of differences between the first and second 3D images.

20. The 3D image comparison program according to claim 19, wherein the color-coded representation uses an additive mixture of three primary colors of light which include red, green, and blue.

21. The 3D image comparison program according to claim 19, wherein the color-coded representation uses a subtractive mixture of three complementary primary colors including cyan, magenta, and yellow.

22. The 3D image comparison program according to claim 21, wherein the subtractive mixture of colors further uses black in addition to the three complementary primary colors.

23. The 3D image comparison program according to claim 18, wherein the first 3D image is given as 3D surface data in CAD data form.

24. The 3D image comparison program according to claim 18, wherein the second 3D image is given as a set of points obtained through measurement of an object.

25. A three-dimensional (3D) comparison method for comparing a first 3D image with a second 3D image and displaying differences therebetween, the method comprising the steps of:
(a) producing a 3D differential image by converting the first and second 3D images into voxel form and making a comparison therebetween;
(b) producing, with respect to a surface voxel of the 3D differential image, fine-voxel images that provide details of the first and second 3D images at a higher resolution than that of the 3D differential image;
(c) determining a representation scheme from differences between the first and second 3D images in the fine-voxel images thereof; and
(d) displaying the 3D differential image including the surface voxel drawn in the determined representation scheme.

26. A three-dimensional (3D) comparison method for comparing a first 3D image with a second 3D image and displaying differences therebetween, the method comprising the steps of:
(a) producing a 3D differential image by converting the first and second 3D images into voxel form and making a comparison therebetween;
(b) extracting a dissimilar part from the 3D differential image, thus permitting an outermost layer of matched voxels to appear;
(c) counting voxel mismatches perpendicularly from each surface of a reference voxel that is selected from the outermost layer of matched voxels, and determining a representation scheme for each surface of the reference voxel, based on the voxel mismatch count; and
(d) displaying each surface of the reference voxel in the corresponding representation scheme.

27. A three-dimensional (3D) comparison method for comparing a first 3D image with a second 3D image and displaying differences therebetween, the method comprising the steps of:
(a) producing a 3D differential image by converting the first and second 3D images into voxel form and making a comparison therebetween;
(b) calculating a ratio of the number of surface voxels of a dissimilar part of the 3D differential image to the total number of voxels constituting the dissimilar part, and based on the ratio, determining a representation scheme for visualizing voxel mismatches on the 3D differential image; and
(c) displaying the dissimilar part of the 3D differential image in the representation scheme determined from the ratio.

28. A three-dimensional (3D) comparison device for comparing a first 3D image with a second 3D image and displaying differences therebetween, comprising:
a differential image generator that produces a 3D differential image by converting the first and second 3D images into voxel form and making a comparison therebetween;
a fine differential image generator that produces, with respect to a surface of the 3D differential image, fine-voxel images that provide details of the first and second 3D images at a higher resolution than that of the 3D differential image;
a display scheme determiner that determines a representation scheme for visualizing a dissimilar part of the 3D differential image, based on detailed differences between the first and second 3D images that are found in the 3D fine differential image; and
a difference display unit that displays voxel comparison results by drawing the 3D differential image in the determined representation scheme.

29. A three-dimensional (3D) comparison device for comparing a first 3D image with a second 3D image and displaying differences therebetween, comprising:
a differential image generator that produces a 3D differential image by converting the first and second 3D images into voxel form and making a comparison therebetween;
a surface-specific difference evaluator that extracts a dissimilar part from the 3D differential image to permit an outermost layer of matched voxels to appear, counts voxel mismatches perpendicularly from each surface of a reference voxel that is selected from the outermost layer of matched voxels, and determines a representation scheme for each surface of the reference voxel, based on the voxel mismatch count; and
a surface-specific difference display unit that displays each surface of the reference voxel in the corresponding representation scheme.

30. A three-dimensional (3D) comparison device for comparing a first 3D image with a second 3D image and displaying differences therebetween, comprising:
a differential image generator that produces a 3D differential image by converting the first and second 3D images into voxel form and making a comparison therebetween;
a difference ratio calculator that calculates a ratio of the number of surface voxels of a dissimilar part of the 3D differential image to the total number of voxels constituting the dissimilar part, and based on the ratio, determining a representation scheme for visualizing voxel mismatches on the 3D differential image; and
a difference ratio display unit that displays the dissimilar part of the 3D differential image in the representation scheme determined from the ratio.

31. A computer-readable storage medium storing a three-dimensional (3D) comparison program for comparing a first 3D image with a second 3D image and displaying differences therebetween, the program causing a computer to perform the steps of:
(a) producing a 3D differential image by converting the first and second 3D images into voxel form and making a comparison therebetween;
(b) producing, with respect to a surface voxel of the 3D differential image, fine-voxel images that provide details of the first and second 3D images at a higher resolution than that of the 3D differential image;
(c) determining a representation scheme from differences between the first and second 3D images in the fine-voxel images thereof; and
(d) displaying the 3D differential image including the surface voxel drawn in the determined representation scheme.

32. A computer-readable storage medium storing a three-dimensional (3D) comparison program for comparing a first 3D image with a second 3D image and displaying differences therebetween, the program causing a computer to perform the steps of:
(a) producing a 3D differential image by converting the first and second 3D images into voxel form and making a comparison therebetween;
(b) extracting a dissimilar part from the 3D differential image, thus permitting an outermost layer of matched voxels to appear;
(c) counting voxel mismatches perpendicularly from each surface of a reference voxel that is selected from the outermost layer of matched voxels, and determining a representation scheme for each surface of the reference voxel, based on the voxel mismatch count; and
(d) displaying each surface of the reference voxel in the corresponding representation scheme.

33. A computer-readable storage medium storing a three-dimensional (3D) comparison program for comparing a first 3D image with a second 3D image and displaying differences therebetween, the program causing a computer to perform the steps of:
(a) producing a 3D differential image by converting the first and second 3D images into voxel form and making a comparison therebetween;
(b) calculating a ratio of the number of surface voxels of a dissimilar part of the 3D differential image to the total number of voxels constituting the dissimilar part, and based on the ratio, determining a representation scheme for visualizing voxel mismatches on the 3D differential image; and
(c) displaying the dissimilar part of the 3D differential image in the representation scheme determined from the ratio.
